(19) United States
(12) Patent Application Publication
(10) Pub. No.: US 2026/0320122 A1
(43) Pub. Date: Oct. 15, 2026

(54) VIDEO TAG PROCESSING METHOD AND APPARATUS, COMPUTER DEVICE, AND STORAGE MEDIUM

(71) Applicant: Tencent Technology (Shenzhen) Company Limited, Shenzhen (CN)

(72) Inventor: Shizhe CHEN, Shenzhen (CN)

(73) Assignee: Tencent Technology (Shenzhen) Company Limited, Shenzhen, GD (CN)

(21) Appl. No.: 19/678,979

(22) Filed: May 15, 2026

Related U.S. Application Data
(63) Continuation of application No. PCT/CN2025/083151, filed on Mar. 18, 2025.

(30) Foreign Application Priority Data
Apr. 26, 2024 (CN) 202410511376.2

(51) Int. Cl. G06F 16/78; G06F 16/75; G06F 16/783; G06F 40/20; G06V 10/75; G06V 10/774; G06V 20/40

(52) U.S. Cl. CPC G06F 16/7867; G06F 16/75; G06F 16/7847; G06F 40/20; G06V 10/751; G06V 10/774; G06V 20/46

(57) ABSTRACT

A video tag processing method includes: determining a to-be-processed video, and extracting modality information of at least two modalities for the video; separately performing cross retrieval based on the modality information of the at least two modalities and feature dimensions of the at least two modalities to obtain respective multi-modal retrieval tags of the modality information of the at least two modalities; determining at least one candidate tag for the video based on the respective multi-modal retrieval tags of the modality information of the at least two modalities; and performing tag prediction based on the at least one candidate tag and the modality information of the at least two modalities to obtain a video tag for the video.

### RELATED APPLICATION

This application is a continuation of International Patent Application No. PCT/CN2025/083151, filed Mar. 18, 2025, which claims priority to Chinese Patent Application No. 2024105113762, entitled “VIDEO TAG PROCESSING METHOD AND APPARATUS, COMPUTER DEVICE, AND STORAGE MEDIUM” filed on Apr. 26, 2024. The contents of International Patent Application No. PCT/CN2025/083151 and Chinese Patent Application No. 2024105113762 are each incorporated herein by reference in their entirety.

### FIELD OF THE TECHNOLOGY

This application relates to the field of computer technologies, and in particular, to a video tag processing method and apparatus, a computer device, a storage medium, and a computer program product.

### BACKGROUND OF THE DISCLOSURE

As video content becomes increasingly rich and diverse, users have an increasingly urgent requirement for efficiently and accurately browsing and searching for video information. To meet the requirement, a video tag processing task for analyzing video content to tag a video emerges correspondingly. Determining a corresponding tag for video content can help a user quickly understand the video content, implement precise searching and personalized recommendation, and further provide strong support for content management and advertisement positioning. However, currently, tag identification accuracy for various types of video content is limited.

### SUMMARY

According to embodiments provided in this application, a video tag processing method and apparatus, a computer device, a computer-readable storage medium, and a computer program product are provided.

According to a first aspect, this application provides a video tag processing method performed by a computer device. The method includes:
determining a to-be-processed video, and extracting modality information of at least two modalities for the video;
separately performing cross retrieval based on the modality information of the at least two modalities and feature dimensions of the at least two modalities to obtain respective multi-modal retrieval tags of the modality information of the at least two modalities;
determining at least one candidate tag for the video based on the respective multi-modal retrieval tags of the modality information of the at least two modalities; and
performing tag prediction based on the at least one candidate tag and the modality information of the at least two modalities to obtain a video tag for the video.

According to a second aspect, this application further provides a video tag processing apparatus. The apparatus includes:
a modality information extraction module, configured to determine a to-be-processed video, and extracting modality information of at least two modalities for the video;
a cross retrieval module, configured to separately perform cross retrieval based on the modality information of the at least two modalities and feature dimensions of the at least two modalities to obtain respective multi-modal retrieval tags of the modality information of the at least two modalities;
a candidate tag determining module, configured to determine at least one candidate tag for the video based on the respective multi-modal retrieval tags of the modality information of the at least two modalities; and
a tag prediction module, configured to perform tag prediction based on the at least one candidate tag and the modality information of the at least two modalities to obtain a video tag for the video.

According to a third aspect, this application further provides a computer device. The computer device includes a memory and a processor. The memory has computer-readable instructions stored therein. The processor, when executing the computer-readable instructions, implements the operations of the foregoing video tag processing method.

According to a fourth aspect, this application further provides a computer-readable storage medium. The computer-readable storage medium has computer-readable instructions stored therein. When the computer-readable instructions are executed by a processor, the operations of the foregoing video tag processing method are implemented.

According to a fifth aspect, this application further provides a computer program product. The computer program product includes computer-readable instructions. When the computer-readable instructions are executed by a processor, the operations of the foregoing video tag processing method are implemented.

Details of one or more embodiments of this application are provided in the accompanying drawings and descriptions below. Other features and advantages of this application become clear with reference to the specification, the accompanying drawings, and the claims.

### BRIEF DESCRIPTION OF THE DRAWINGS

To describe the technical solutions in the embodiments of this application or the conventional technology more clearly, the following briefly describes the accompanying drawings needed for describing the embodiments or the conventional technology. Clearly, the accompanying drawings in the following descriptions show merely the embodiments of this application, and a person of ordinary skill in the art may still derive other drawings from the disclosed accompanying drawings without creative efforts.

FIG. 1 is a diagram of an application environment of a video tag processing method according to an embodiment.

FIG. 2 is a schematic flowchart of a video tag processing method according to an embodiment.

FIG. 3A is a schematic flowchart of cross retrieval according to an embodiment.

FIG. 3B is a schematic flowchart of implementing a video tag processing method based on three modalities according to an embodiment.

FIG. 4 is a schematic flowchart of determining a tag by using a tag prediction model according to an embodiment.

FIG. 5 is a schematic flowchart of performing cross retrieval based on three types of modality information according to an embodiment.

FIG. 6 is a schematic flowchart of performing cross retrieval based on a multi-modal feature tag library according to an embodiment.

FIG. 7 is a schematic flowchart of performing cross retrieval based on two types of modality information according to an embodiment.

FIG. 8 is a schematic flowchart of determining a tag based on multi-modal information according to an embodiment.

FIG. 9 is a schematic flowchart of a video tag processing method according to another embodiment.

FIG. 10 is a diagram of an application scenario of a video tag processing method according to an embodiment.

FIG. 11 is a diagram of feature matching for a text-image pair according to an embodiment.

FIG. 12 is a schematic flowchart of cross retrieval according to an embodiment.

FIG. 13 is a block diagram of a structure of a video tag processing apparatus according to an embodiment.

FIG. 14 is a diagram of an internal structure of a computer device according to an embodiment.

### DESCRIPTION OF EMBODIMENTS

The technical solutions in the embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

To make the objectives, technical solutions, and advantages of this application clearer, the following further describes this application in detail with reference to the accompanying drawings and the embodiments. The specific embodiments described herein are merely intended to explain this application but not to limit this application.

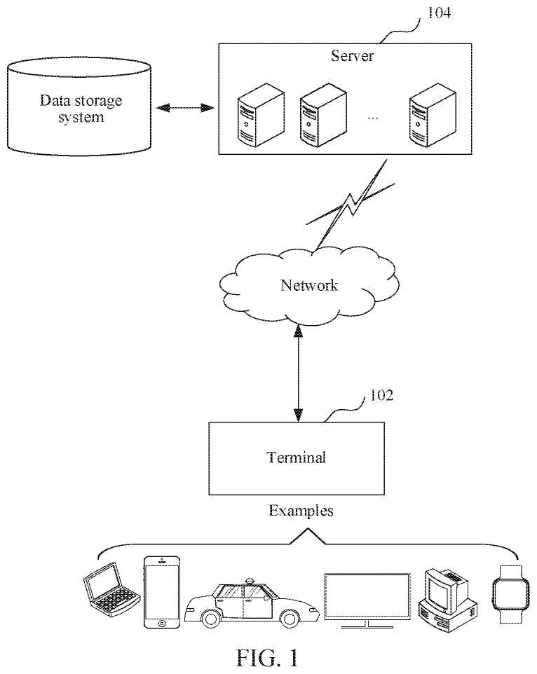

A video tag processing method provided in the embodiments of this application may be applied to an application environment shown in FIG. 1. A terminal 102 communicates with a server 104 through a network. A data storage system may store data that the server 104 needs to process. The data storage system may be disposed separately, or may be integrated on the server 104, or may be deployed on a cloud or another server. The terminal 102 may transmit a to-be-processed video to the server 104. After the server 104 receives the to-be-processed video, for the to-be-processed video, the server 104 separately performs cross retrieval based on modality information of at least two modalities that is extracted for the video and feature dimensions of the at least two modalities, determines at least one candidate tag for the video based on obtained respective multi-modal retrieval tags of the modality information of the at least two modalities, and performs tag prediction based on the at least one candidate tag and the modality information of the at least two modalities to obtain a video tag for the video. The server 104 may feed back the obtained video tag for the video to the terminal 102. In addition, in some embodiments, the video tag processing method may alternatively be independently implemented by the server 104 or the terminal 102. For example, the terminal 102 may directly perform video tag processing on a to-be-processed video, or the server 104 may obtain a to-be-processed video from a data storage system, and perform video tag processing on the to-be-processed video.

The terminal 102 may be but is not limited to a desktop computer, a notebook computer, a smartphone, a tablet computer, an Internet of Things device, and a portable wearable device. The Internet of Things device may be a smart speaker, a smart television, a smart air conditioner, a smart in-vehicle device, or the like. The portable wearable device may be a smart watch, a smart band, a head-mounted device, or the like. The server 104 may be implemented as an independent server or a server cluster including a plurality of servers, or may be a cloud server.

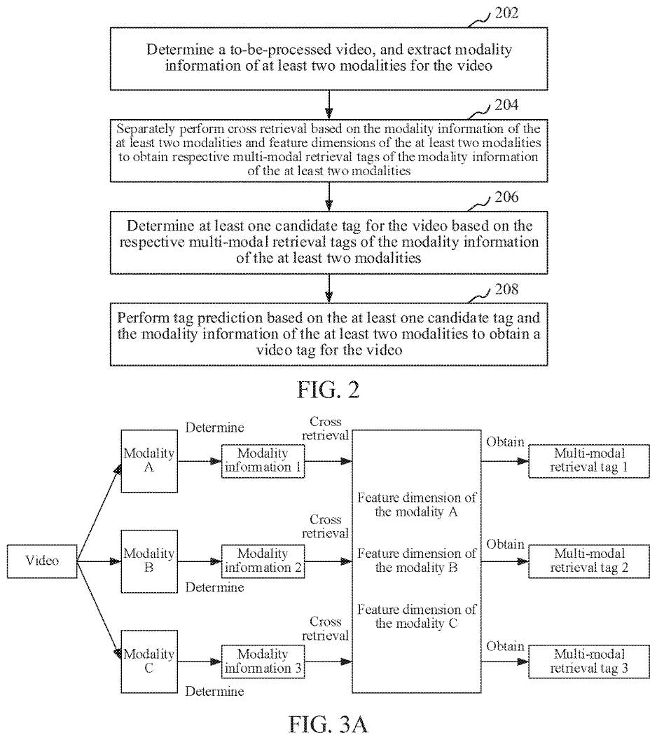

In an exemplary embodiment, as shown in FIG. 2, a video tag processing method is provided. The method is performed by a computer device, and specifically, may be independently performed by a computer device like a terminal or a server, or may be jointly performed by a terminal and a server. In this embodiment of this application, an example in which the method is applied to the server in FIG. 1 is used for description, and the method includes the following operation 202 to operation 208.

Operation 202: Determine a to-be-processed video, and extract modality information of at least two modalities for the video.

The to-be-processed video is a video for which a tag needs to be determined. The tag of the video is a keyword about the video. A corresponding tag is associated with the video, so that the video can be accurately classified, retrieved, pushed, and the like. The modalities are different types of information, and may specifically include but are not limited to a visual modality, a sound modality, a textual modality, and the like. The visual modality may include content that can be seen in the video, such as an image, a color, and an action. These visual elements provide direct visual experience, and are important components of video information transmission. The sound modality includes sound that can be heard in the video, such as voice, music, and background sound. The sound modality adds an auditory element to the video, and enhances immersion and emotional resonance. The textual modality is a text resource that can describe video content, such as a subtitle, a title, and a tag. The textual modality provides additional information for the video, and helps better understand the video content. The modality information may specifically include various types of information such as visual modality information corresponding to the visual modality, sound modality information corresponding to the sound modality, and textual modality information corresponding to the textual modality.

Specifically, when the computer device performing the video tag processing method includes the server, the server may determine a video on which tag processing needs to be performed, and extract modality information of different modalities for the video. During specific implementation, the server may extract two types of modality information or three types of modality information for the video based on two modalities or three modalities. For example, the server may extract the visual modality information corresponding to the visual modality from the video, where the visual modality information may include a video frame in the video; the server may extract the sound modality information corresponding to the sound modality from the video, where the sound modality information may include voice and music in the video; the server may further extract the textual modality information corresponding to the textual modality from the video, where the textual modality information may include information such as a subtitle and a title of the video; and the server may further perform character recognition on the video frame in the video to obtain a character recognition result, where the character recognition result may be used as textual modality information of the video. In some applications, the server may further perform speech recognition on audio included in the video to obtain a semantic recognition result, where the semantic recognition result may be used as textual modality information of the video.

Operation 204: Separately perform cross retrieval based on the modality information of the at least two modalities and feature dimensions of the at least two modalities to obtain respective multi-modal retrieval tags of the modality information of the at least two modalities.

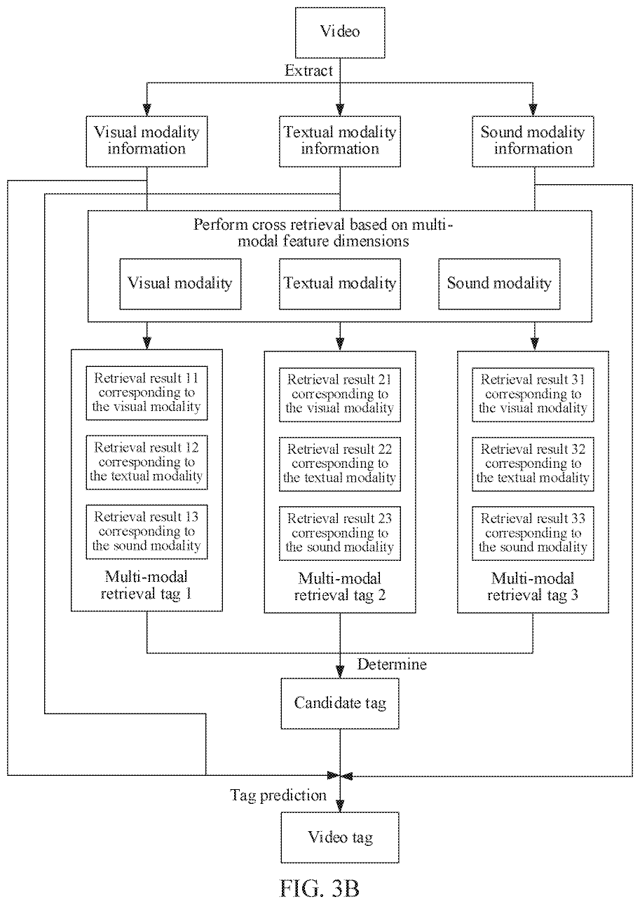

The cross retrieval is processing of performing multi-modal tag retrieval on modality information of each modality based on the feature dimensions of the modalities. To be specific, for the modality information of each modality, tag retrieval is performed based on the feature dimensions of the modalities. Each modality may correspond to a respective feature dimension. For example, the textual modality may correspond to a textual feature dimension, the visual modality may correspond to a visual feature dimension, and an audio modality may correspond to the visual feature dimension. For example, as shown in FIG. 3A, modality information of three modalities is extracted for a video, including modality information 1 corresponding to a modality A, modality information 2 corresponding to a modality B, and modality information 3 corresponding to a modality C. During cross retrieval, for the modality information 1, tag retrieval may be separately performed based on feature dimensions of the modality A, the modality B, and the modality C; and similarly, for the modality information 2 and the modality information 3, tag retrieval may be separately performed based on the feature dimensions of the modality A, the modality B, and the modality C, to separately obtain a multi-modal retrieval tag 1 corresponding to the modality information 1, a multi-modal retrieval tag 2 corresponding to the modality information 2, and a multi-modal retrieval tag 3 corresponding to the modality information 3. In this way, tag retrieval is performed on same modality information in a multi-modal feature dimension. The multi-modal retrieval tag is a retrieval result obtained by performing tag retrieval on same modality information in a multi-modal feature dimension, and may specifically include video tags obtained by separately retrieving one type of modality information in feature dimensions of various modalities. For example, for the modality information 1, when tag retrieval is performed based on the feature dimensions of the modality A, the modality B, and the modality C, a retrieval tag 1 in a feature dimension of the modality A, a retrieval tag 2 in a feature dimension of the modality B, and a retrieval tag 3 in a feature dimension of the modality C may be respectively obtained, and the multi-modal retrieval tag of the modality information 1 may be obtained based on the retrieval tag 1, the retrieval tag 2, and the retrieval tag 3.

In some embodiments, for the modality information of each modality, the server may perform cross retrieval based on feature dimensions of a plurality of modalities. The plurality of modalities may specifically include various modalities to which modality information extracted for the video belongs. For each type of modality information, tag retrieval may be performed in a feature dimension of each modality to retrieve a tag matching the modality information, to obtain a tag retrieval result in the feature dimension of each modality. A multi-modal retrieval tag of the modality information may be obtained based on tag retrieval results in feature dimensions of various modalities. The server traverses each type of modality information in the modality information of the at least two modalities to obtain respective multi-modal retrieval tags of the modality information of the at least two modalities. During specific applications, each modality feature and a corresponding tag may be pre-constructed for a feature dimension of each modality. When cross retrieval is performed based on modality information, matching may be performed between the modality information and each modality feature, a tag corresponding to a matching modality feature is used as a tag retrieval result of the modality information in a feature dimension of a corresponding modality. After cross retrieval is performed by traversing feature dimensions of various modalities, a multi-modal retrieval tag corresponding to the modality information may be obtained.

Operation 206: Determine at least one candidate tag for the video based on the respective multi-modal retrieval tags of the modality information of the at least two modalities.

The candidate tag is configured for preliminarily marking a video, and is used as a tag preliminarily determined for the video. The candidate tag is obtained based on respective multi-modal retrieval tags of various types of modality information. For example, the server may synthesize the respective multi-modal retrieval tags of various types of modality information to obtain the at least one candidate tag for the video. In some implementations, the server may collect statistics on the respective multi-modal retrieval tags of various types of modality information. For example, the server may collect statistics on frequency of each tag, and determine the at least one candidate tag based on a statistics collection result. For example, after collecting statistics on the frequency of each tag, the server may use K tags with highest frequency as candidate tags for the video, and a value of K may be set according to an actual requirement. In some embodiments, different weights may be alternatively set for multi-modal retrieval tags corresponding to various types of modality information, so that a candidate tag for the video can be determined based on weights of the respective multi-modal retrieval tags of various types of modality information.

Operation 208: Perform tag prediction based on the at least one candidate tag and the modality information of the at least two modalities to obtain a video tag for the video.

The video tag is a tag finally determined for the to-be-processed video, and the video tag is obtained by performing tag prediction based on the candidate tag for the video and modality information of various modalities. For example, the server may perform tag prediction based on the candidate tag for the video and the modality information of the at least two modalities. For example, the server may input the candidate tag and the modality information of the at least two modalities to a pre-trained tag prediction model for tag prediction, to obtain the video tag for the video. In some embodiments, the server may alternatively separately determine respective features of the candidate tag and the modality information of the at least two modalities, and fuse the respective features of the candidate tag and the modality information of the at least two modalities to obtain a tag prediction feature. The server may perform tag prediction based on the tag prediction feature obtained through fusion. For example, the server may input the tag prediction feature to a pre-trained tag prediction model for tag prediction, to obtain the video tag for the video.

In a specific application, as shown in FIG. 3B, for the to-be-processed video, the server may extract the visual modality information corresponding to the visual modality, the textual modality information corresponding to the textual modality, and the sound modality information corresponding to the sound modality. The server may perform cross retrieval based on various types of modality information in a multi-modal feature dimension. The multi-modal feature dimension includes the visual modality, the textual modality, and the sound modality. Specifically, for the visual modality information, cross retrieval may be performed based on feature dimensions of the visual modality, the textual modality, and the sound modality to obtain a multi-modal retrieval tag 1 of the visual modality information. The multi-modal retrieval tag 1 includes a retrieval result 11 corresponding to the visual modality, a retrieval result 12 corresponding to the textual modality, and a retrieval result 13 corresponding to the sound modality. The retrieval result 11 is a retrieval result obtained by performing tag retrieval based on the visual modality information in a feature dimension of the visual modality. The retrieval result 12 is a retrieval result obtained by performing tag retrieval based on the visual modality information in a feature dimension of the textual modality. The retrieval result 13 is a retrieval result obtained by performing tag retrieval based on the visual modality information in a feature dimension of the sound modality. Similarly, a multi-modal retrieval tag 2 obtained for the textual modality information includes a retrieval result 21 corresponding to the visual modality, a retrieval result 22 corresponding to the textual modality, and a retrieval result 23 corresponding to the sound modality, a multi-modal retrieval tag 3 obtained for the sound modality information includes a retrieval result 31 corresponding to the visual modality, a retrieval result 32 corresponding to the textual modality, and a retrieval result 33 corresponding to the sound modality. The server may determine the at least one candidate tag for the video comprehensively based on the multi-modal retrieval tag 1, the multi-modal retrieval tag 2, and the multi-modal retrieval tag 3. The server performs tag prediction based on the candidate tag, the visual modality information, the textual modality information, and the sound modality information to obtain the video tag.

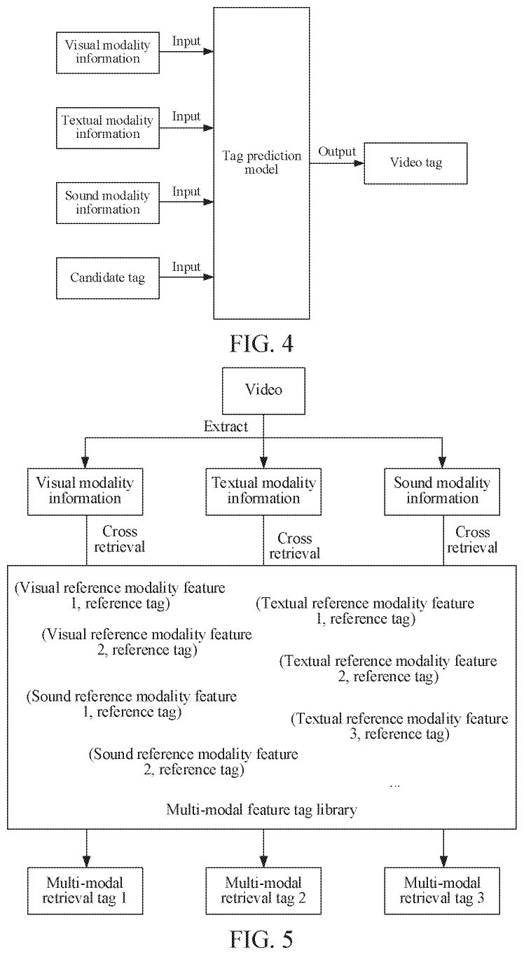

In a specific application, as shown in FIG. 4, when the server performs tag prediction based on the candidate tag, the visual modality information, the textual modality information, and the sound modality information, the server may separately input the candidate tag, the visual modality information, the textual modality information, and the sound modality information to the pre-trained tag prediction model, so that the tag prediction model performs tag prediction and outputs the video tag. In some embodiments, the server may alternatively first construct a model input feature based on the candidate tag, the visual modality information, the textual modality information, and the sound modality information, and input the constructed model input feature to the tag prediction model for tag prediction, to obtain the video tag for the video. In some embodiments, when performing tag prediction based on the candidate tag and the modality information, the server may perform tag prediction based on the candidate tag and all types of modality information; or the server may determine, from the modality information of the at least two modalities, modality information of a target modality, where the target modality may be at least a part of modalities selected from the at least two modalities, and the server may perform tag prediction based on the candidate tag and the modality information of the target modality, so that a data size of the modality information can be flexibly adjusted, to improve tag prediction efficiency.

In the foregoing video tag processing method, for a to-be-processed video, cross retrieval is separately performed based on modality information of at least two modalities that is extracted for the video and feature dimensions of the at least two modalities, at least one candidate tag for the video is determined based on obtained respective multi-modal retrieval tags of the modality information of the at least two modalities, and tag prediction is performed based on the at least one candidate tag and the modality information of the at least two modalities to obtain a video tag for the video. Cross retrieval is performed based on the modality information of the at least two modalities of the video, the at least one candidate tag is determined based on the multi-modal retrieval tags obtained through cross retrieval, and tag prediction is performed based on the candidate tag and the modality information of the at least two modalities, so that the candidate tag can be introduced into the tag prediction, to enhance information targeted by the tag prediction, and improve accuracy of determining the video tag.

In an exemplary embodiment, the separately performing cross retrieval based on the modality information of the at least two modalities and feature dimensions of the at least two modalities to obtain respective multi-modal retrieval tags of the modality information of the at least two modalities includes: determining a multi-modal feature tag library, the multi-modal feature tag library including reference modality features of a reference video in the at least two modalities and reference tags that are respectively pre-determined based on the reference modality features; and respectively performing feature matching between the modality information of the at least two modalities and the reference modality features of the reference video in the at least two modalities to obtain a feature matching result, and retrieving the respective multi-modal retrieval tags of the modality information of the at least two modalities from the multi-modal feature tag library based on the feature matching result.

The multi-modal feature tag library is configured for storing various reference modality features and corresponding reference tags. The multi-modal feature tag library may include the reference modality features of the reference video in the at least two modalities and the reference tags respectively corresponding to the reference modality features. The reference video is a video for which a video tag is pre-determined. Corresponding reference modality features may be separately extracted from the reference video in various modalities. For example, the reference modality features may include a visual reference modality feature corresponding to the visual modality, a textual reference modality feature corresponding to the textual modality, or a sound reference modality feature corresponding to the sound modality. An associated reference tag may be correspondingly set for each reference modality feature, and the reference tag is a video tag pre-determined and added for the reference video. The feature matching result is a result obtained by performing feature matching between the modality information of the video and the reference modality features of the reference video. A correlation between the to-be-processed video and the reference video may be determined based on the feature matching result. If the correlation between the to-be-processed video and the reference video is high, the reference tag carried in the reference video is more correlated with a tag of the to-be-processed video, and the reference tag carried in the reference video may be used as a retrieval tag of the to-be-processed video.

In some embodiments, the server may determine a pre-constructed multi-modal feature tag library. During specific implementation, the server may use a historical video as a reference video, and tag the reference video, to be specific, determine a reference tag corresponding to the reference video. In addition, the server may extract reference modality features in different modalities for the reference video, and may specifically perform feature extraction based on modality information in different modalities that corresponds to the reference video, to obtain the reference modality features in different modalities. The server may establish an association relationship between reference tags of the reference video and various reference modality features, to support retrieval for corresponding reference tags based on the reference modality features. The server constructs the multi-modal feature tag library based on the reference modality features of the reference video in the at least two modalities and the reference tags respectively corresponding to the reference modality features. For the modality information of the at least two modalities that is extracted from the video, the server determines a feature matching result between each type of modality information and the reference modality features of the reference video in the at least two modalities. The feature matching result is obtained by performing feature matching between the modality information and the reference modality features of the reference video in the at least two modalities. The server retrieves the respective multi-modal retrieval tags of the modality information of the at least two modalities from the multi-modal feature tag library based on the feature matching result.

In a specific application, as shown in FIG. 5, after extracting the visual modality information, the textual modality information, and the sound modality information for the video, the server may separately perform cross retrieval on the visual modality information, the textual modality information, and the sound modality information in the multi-modal feature tag library. Specifically, the server may perform matching between each piece of visual modality information and each reference modality feature in the multi-modal feature tag library, to obtain a feature matching result. The multi-modal feature tag library may include various reference modality features and corresponding reference tags. The reference modality features may include the visual reference modality feature, the textual reference modality feature, and the sound reference modality feature. Each reference modality feature has a corresponding reference tag. For the obtained feature matching result, the server may determine a feature matching result indicating matching, determine a reference modality feature corresponding to the feature matching result indicating matching, and determine a reference tag corresponding to the reference modality feature from the multi-modal feature tag library. The server may use the determined reference tag as a multi-modal retrieval tag of corresponding modality information. A multi-modal retrieval tag 1, a multi-modal retrieval tag 2, and a multi-modal retrieval tag 3 may be respectively obtained for the visual modality information, the textual modality information, and the sound modality information.

In this embodiment, the server retrieves a corresponding multi-modal retrieval tag from the multi-modal feature tag library based on a feature matching result between each type of modality information and each reference modality feature in the multi-modal feature tag library, to perform cross retrieval in a multi-modal feature dimension by using the multi-modal feature tag library, to ensure accuracy of the cross retrieval and help ensure accuracy of determining the video tag.

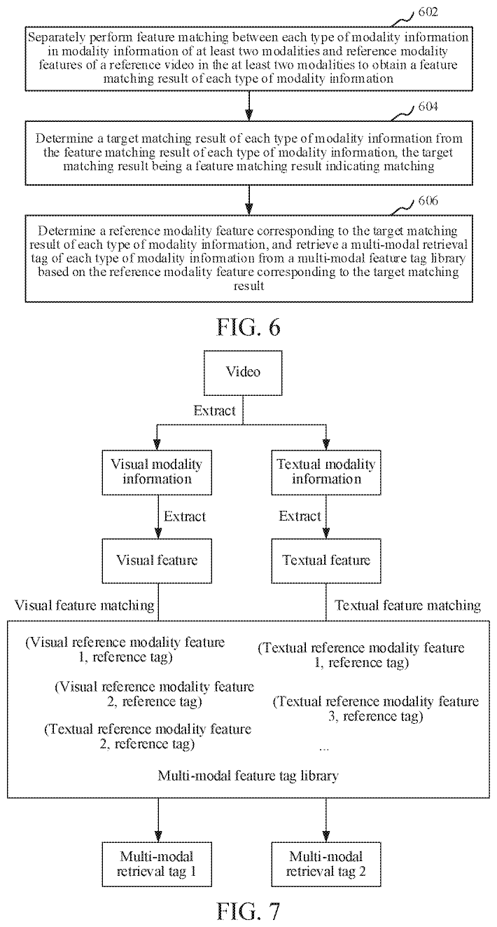

In an exemplary embodiment, as shown in FIG. 6, the respectively performing feature matching between the modality information of the at least two modalities and the reference modality features of the reference video in the at least two modalities to obtain a feature matching result, and retrieving the respective multi-modal retrieval tags of the modality information of the at least two modalities from the multi-modal feature tag library based on the feature matching result includes the following operations:

Operation 602: Separately perform feature matching between each type of modality information in the modality information of the at least two modalities and the reference modality features of the reference video in the at least two modalities to obtain a feature matching result of each type of modality information.

The feature matching result is obtained by performing feature matching between the modality information and each reference modality feature in the multi-modal feature tag library. For example, the server may traverse each type of modality information in the modality information of the at least two modalities, to perform cross retrieval on each type of modality information. Specifically, for each type of modality information, the server may perform feature matching between targeted modality information and each reference modality feature in the multi-modal feature tag library, to obtain a feature matching result of the targeted modality information. During specific implementation, the server may extract a modality information feature from the targeted modality information, and perform feature matching between the extracted modality information feature and each reference modality feature, for example, may perform feature similarity calculation, to obtain a corresponding feature matching result. After various types of modality information are traversed, feature matching results of various types of modality information may be obtained.

Operation 604: Determine a target matching result of each type of modality information from the feature matching result of each type of modality information, the target matching result being a feature matching result indicating matching.

The target matching result is a feature matching result, in the feature matching result, that indicates matching, to be specific, indicates that the modality information matches a corresponding reference modality feature and a correlation between the modality information and the corresponding reference modality feature is high. In some embodiments, for the feature matching result of each type of modality information, the server may determine a target matching result indicating matching. In a specific application, the feature matching result may include a feature similarity. In this case, the server may determine a target matching result on each feature matching result based on a similarity threshold, to determine whether the feature matching result indicates matching. For example, the server may determine a feature matching result with a feature similarity exceeding the similarity threshold as a target matching result indicating matching. The target matching result of each type of modality information may be obtained by performing determining on the feature matching result of each type of modality information.

Operation 606: Determine a reference modality feature corresponding to the target matching result of each type of modality information, and retrieve a multi-modal retrieval tag of each type of modality information from the multi-modal feature tag library based on the reference modality feature corresponding to the target matching result.

Specifically, for each target matching result of each type of modality information, the server may determine a reference modality feature corresponding to the target matching result, the reference modality feature corresponding to the target matching result being a reference modality feature, obtained by performing feature matching against the modality information, of the target matching result; and retrieve a reference tag corresponding to the reference modality feature from the multi-modal feature tag library. The server may use the retrieved reference tag as a tag retrieval result of the modality information. After traversing target matching results of the modality information, the server may obtain a multi-modal retrieval tag of the modality information based on tag retrieval results of the modality information. After traversing various types of modality information, the server may obtain respective multi-modal retrieval tags of the modality information.

In this embodiment, the server performs feature matching between each type of modality information and each reference modality feature in the multi-modal feature tag library, and retrieves a multi-modal retrieval tag of the modality information from the multi-modal feature tag library based on a reference modality feature corresponding to a target matching result indicating matching. After various types of modality information are traversed, respective multi-modal retrieval tags of the modality information may be obtained. In this way, the respective multi-modal retrieval tags of various types of modality information can be accurately retrieved based on feature matching. This helps improve accuracy of determining the video tag based on the multi-modal retrieval tags.

In an exemplary embodiment, the at least two modalities include the visual modality and the textual modality; the modality information of the at least two modalities includes the visual modality information of the video and the textual modality information of the video; the multi-modal feature tag library includes the visual reference modality feature of the reference video in the visual modality, a visual reference tag corresponding to the visual reference modality feature, the textual reference modality feature of the reference video in the textual modality, and a textual reference tag corresponding to the textual reference modality feature; and the respectively performing feature matching between the modality information of the at least two modalities and the reference modality features of the reference video in the at least two modalities to obtain a feature matching result, and retrieving the respective multi-modal retrieval tags of the modality information of the at least two modalities from the multi-modal feature tag library based on the feature matching result includes: performing feature extraction based on the visual modality information to obtain a visual feature, and performing feature extraction based on the textual modality information to obtain a textual feature; performing visual feature matching between the visual feature and each of the visual reference modality feature and the textual reference modality feature to obtain a visual feature matching result, and obtaining a multi-modal retrieval tag of the visual modality information from the visual reference tag and the textual reference tag based on the visual feature matching result; and performing textual feature matching between the textual feature and each of the visual reference modality feature and the textual reference modality feature to obtain a textual feature matching result, and obtaining a multi-modal retrieval tag of the textual modality information from the visual reference tag and the textual reference tag based on the textual feature matching result.

The at least two modalities include the visual modality and the textual modality, and the modality information extracted for the to-be-processed video includes the visual modality information corresponding to the visual modality and the textual modality information corresponding to the textual modality. The visual feature is a video feature extracted based on the visual modality information, and the textual feature is a video feature extracted based on the textual modality information. The multi-modal feature tag library includes the visual reference modality feature and the visual reference tag corresponding to the visual reference modality feature, and the visual reference modality feature is a video feature of the reference video in the visual modality. The multi-modal feature tag library further includes the textual reference modality feature and the textual reference tag corresponding to the textual reference modality feature, and the textual reference modality feature is a video feature of the reference video in the textual modality.

For example, in a scenario in which the extracted modality information includes the visual modality information and the textual modality information, involved modalities include the visual modality and the textual modality. The server may separately perform feature extraction based on the visual modality information and the textual modality information, for example, may separately perform feature extraction on the visual modality information and the textual modality information by using a multi-modal feature extraction model, to obtain the visual feature and the textual feature. In some embodiments, the server may alternatively separately perform feature extraction on the visual modality information and the textual modality information by using different feature extraction models, for example, may extract the visual feature from the visual modality information by using a visual feature extraction model, and extract the textual feature from the textual modality information by using a textual feature extraction model.

For the visual feature, the server may perform visual feature matching between the visual feature and each of the visual reference modality feature and the textual reference modality feature in the multi-modal feature tag library, and may specifically calculate a feature similarity between the visual feature and each of the visual reference modality feature and the textual reference modality feature, to obtain the visual feature matching result. The server may determine the multi-modal retrieval tag of the visual modality information from the visual reference tag and the textual reference tag based on the visual feature matching result, and may specifically obtain the multi-modal retrieval tag based on a reference tag corresponding to a visual feature matching result indicating matching. For the textual feature, similar to the visual feature, the server may perform textual feature matching between the textual feature and each of the visual reference modality feature and the textual reference modality feature in the multi-modal feature tag library, and may specifically calculate a feature similarity between the textual feature and each of the visual reference modality feature and the textual reference modality feature, to obtain the textual feature matching result. The server may determine the multi-modal retrieval tag of the textual modality information from the visual reference tag and the textual reference tag based on the textual feature matching result, and may specifically obtain the multi-modal retrieval tag based on a reference tag corresponding to a textual feature matching result indicating matching.

In a specific application, as shown in FIG. 7, the visual modality information and the textual modality information are extracted from the to-be-processed video based on the visual modality and the textual modality respectively. The server may separately perform feature extraction on the visual modality information and the textual modality information to obtain the visual feature and the textual feature. The server may perform visual feature matching between the visual feature and the multi-modal feature tag library, and may specifically perform visual feature matching between the visual feature and the visual reference modality feature and the textual reference modality feature in the multi-modal feature tag library, and determine a multi-modal retrieval tag 1 of the visual modality information based on an obtained visual feature matching result. For the textual feature, the server may perform textual feature matching between the textual feature and the visual reference modality feature and the textual reference modality feature in the multi-modal feature tag library, and determine a multi-modal retrieval tag 2 of the textual modality information based on an obtained textual feature matching result.

In this embodiment, in an application scenario of the textual modality and the visual modality, the server extracts the visual feature and the textual feature based on the visual modality information and the textual modality information respectively, performs feature matching between each of the visual feature and the textual feature and each of the visual reference modality feature and the textual reference modality feature in the multi-modal feature tag library, and determines a multi-modal retrieval tag based on a corresponding feature matching result. In this way, the multi-modal retrieval tag of the visual modality information and the multi-modal retrieval tag of the textual modality information can be accurately determined. This helps ensure accuracy of determining the video tag.

In an exemplary embodiment, the performing visual feature matching between the visual feature and each of the visual reference modality feature and the textual reference modality feature to obtain a visual feature matching result, and obtaining a multi-modal retrieval tag of the visual modality information from the visual reference tag and the textual reference tag based on the visual feature matching result includes: performing visual feature matching between the visual feature and the visual reference modality feature to obtain a first visual feature matching result; determining a first visual feature matching result indicating matching, determining a visual reference modality feature corresponding to the first visual feature matching result indicating matching, and determining a first visual modality retrieval tag from the visual reference tag based on the visual reference modality feature corresponding to the first visual feature matching result indicating matching; performing visual feature matching between the visual feature and the textual reference modality feature to obtain a second visual feature matching result; determining a second visual feature matching result indicating matching, determining a textual reference modality feature corresponding to the second visual feature matching result indicating matching, and determining a first textual modality retrieval tag from the textual reference tag based on the textual reference modality feature corresponding to the second visual feature matching result indicating matching; and obtaining the multi-modal retrieval tag of the visual modality information based on the first visual modality retrieval tag and the first textual modality retrieval tag.

For example, for the visual feature, the server performs visual feature matching between the visual feature and each visual reference modality feature in the multi-modal feature tag library, and may specifically perform feature similarity calculation, to obtain the first visual feature matching result. The server may determine a feature matching status indicated by each first visual feature matching result. The server determines the first visual feature matching result indicating matching, and further determines the visual reference modality feature corresponding to the first visual feature matching result indicating matching, to be specific, indicating that the visual reference modality feature matches the visual feature. The server may determine a reference tag corresponding to the visual reference modality feature from visual reference tags based on the visual reference modality feature, and use the determined reference tag as the first visual modality retrieval tag. The server performs visual feature matching between the visual feature and each textual reference modality feature in the multi-modal feature tag library, and may specifically perform feature similarity calculation, to obtain the second visual feature matching result. The server determines the second visual feature matching result indicating matching, and determines the textual reference modality feature corresponding to the second visual feature matching result indicating matching, to be specific, indicating that the textual reference modality feature matches the visual feature. The server may determine a reference tag corresponding to the textual reference modality feature from textual reference tags based on the textual reference modality feature, and use the determined reference tag as the first textual modality retrieval tag. The server obtains the multi-modal retrieval tag of the visual modality information based on the first visual modality retrieval tag and the first textual modality retrieval tag, and may specifically combine the first visual modality retrieval tag and the first textual modality retrieval tag to obtain the multi-modal retrieval tag of the visual modality information.

In this embodiment, the server performs visual feature matching between the visual feature and each of the visual reference modality feature and the textual reference modality feature, determines a corresponding visual modality retrieval tag and textual modality retrieval tag based on respectively obtained visual feature matching results, and may obtain the multi-modal retrieval tag of the visual modality information by combining the visual modality retrieval tag and the textual modality retrieval tag. Performing tag retrieval in feature dimensions of the visual modality and the textual modality based on the visual feature can ensure accuracy of the multi-modal retrieval tag, to help improve accuracy of determining the video tag.

In an exemplary embodiment, the performing textual feature matching between the textual feature and each of the visual reference modality feature and the textual reference modality feature to obtain a textual feature matching result, and obtaining a multi-modal retrieval tag of the textual modality information from the visual reference tag and the textual reference tag based on the textual feature matching result includes: performing textual feature matching between the textual feature and the visual reference modality feature to obtain a first textual feature matching result; determining a first textual feature matching result indicating matching, determining a visual reference modality feature corresponding to the first textual feature matching result indicating matching, and determining a second visual modality retrieval tag from the visual reference tag based on the visual reference modality feature corresponding to the first textual feature matching result indicating matching; performing textual feature matching between the textual feature and the textual reference modality feature to obtain a second textual feature matching result; determining a second textual feature matching result indicating matching, determining a textual reference modality feature corresponding to the second textual feature matching result indicating matching, and determining a second textual modality retrieval tag from the textual reference tag based on the textual reference modality feature corresponding to the second textual feature matching result indicating matching; and obtaining the multi-modal retrieval tag of the textual modality information based on the second visual modality retrieval tag and the second textual modality retrieval tag.

Specifically, for the textual feature, the server performs textual feature matching between the textual feature and each visual reference modality feature in the multi-modal feature tag library, and may specifically perform feature similarity calculation, to obtain the first textual feature matching result. The server may determine a feature matching status indicated by each first textual feature matching result. The server determines the first textual feature matching result indicating matching, and determines the visual reference modality feature corresponding to the first textual feature matching result indicating matching, to be specific, indicating that the visual reference modality feature matches the textual feature. The server may determine a reference tag corresponding to the visual reference modality feature from visual reference tags based on the visual reference modality feature, and use the determined reference tag as the second visual modality retrieval tag. The server performs textual feature matching between the visual feature and each textual reference modality feature in the multi-modal feature tag library, and may specifically perform feature similarity calculation, to obtain the second textual feature matching result. The server determines the second textual feature matching result indicating matching, and determines the textual reference modality feature corresponding to the second textual feature matching result indicating matching, to be specific, indicating that the textual reference modality feature matches the textual feature. The server may determine a reference tag corresponding to the textual reference modality feature from textual reference tags based on the textual reference modality feature, and use the determined reference tag as the second textual modality retrieval tag. The server obtains the multi-modal retrieval tag of the textual modality information based on the second visual modality retrieval tag and the second textual modality retrieval tag, and may specifically combine the second visual modality retrieval tag and the second textual modality retrieval tag to obtain the multi-modal retrieval tag of the textual modality information.

In this embodiment, the server performs textual feature matching between the textual feature and each of the visual reference modality feature and the textual reference modality feature, determines a corresponding visual modality retrieval tag and textual modality retrieval tag based on respectively obtained textual feature matching results, and may obtain the multi-modal retrieval tag of the textual modality information by combining the visual modality retrieval tag and the textual modality retrieval tag. Performing tag retrieval in feature dimensions of the visual modality and the textual modality based on the textual feature can ensure accuracy of the multi-modal retrieval tag, to help improve accuracy of determining the video tag.

In an exemplary embodiment, the operation of performing feature extraction based on the visual modality information to obtain a visual feature, and performing feature extraction based on the textual modality information to obtain a textual feature is implemented by a multi-modal feature extraction model, and an operation of training the multi-modal feature extraction model includes: obtaining a sample pair, the sample pair including visual content and description text for the visual content; separately performing feature extraction on the visual content and the description text by using a to-be-trained initial multi-modal feature extraction model to obtain a sample-pair visual feature of the visual content and a sample-pair textual feature of the description text; and updating the initial multi-modal feature extraction model based on the sample-pair visual feature and the sample-pair textual feature to obtain the multi-modal feature extraction model.

The multi-modal feature extraction model supports feature extraction for information of a plurality of modalities, and the multi-modal feature extraction model may be obtained through pre-training based on various artificial neural network algorithms or a deep learning algorithm according to an actual requirement. For example, the server may obtain the multi-modal feature extraction model through pre-training based on at least one of a convolutional neural network (CNN) algorithm, a contrastive language-image pre-training (CLIP) algorithm, a recurrent neural network (RNN) algorithm, a long short-term memory (LSTM) algorithm, a generative adversarial network (GAN) algorithm, an autoencoder (AE) algorithm, or a deep belief network (DBN) algorithm.

The sample pair is sample data for training the multi-modal feature extraction model, and the sample pair may include visual content and description text for the visual content. The visual content may include image content or video content, and the description text is configured for describing the visual content. The sample pair may include a positive sample pair and a negative sample pair. The positive sample pair is a sample pair in which visual content matches description text. The negative sample pair is a sample pair in which visual content does not match description text. The initial multi-modal feature extraction model is a raw model that needs to be trained.

In some embodiments, the server may obtain the sample pair, and perform feature extraction on the sample pair by using the to-be-trained initial multi-modal feature extraction model. Specifically, the server performs feature extraction on the visual content by using the initial multi-modal feature extraction model to obtain the sample-pair visual feature of the visual content, and performs feature extraction on the description text by using the initial multi-modal feature extraction model to obtain the sample-pair textual feature of the description text. The server may update the initial multi-modal feature extraction model based on the sample-pair visual feature and the sample-pair textual feature outputted by the initial multi-modal feature extraction model and continue to perform training. Specifically, the server may update a model parameter of the initial multi-modal feature extraction model based on a degree of matching between the sample-pair visual feature and the sample-pair textual feature, continue to perform training by using a next sample pair, and end training when a training ending condition is met, to obtain a trained multi-modal feature extraction model. The trained multi-modal feature extraction model performs feature extraction on inputted multi-modal information, and outputs features in corresponding modalities. The training ending condition may be flexibly set according to an actual requirement. For example, when a convergence condition is met, model output precision is satisfied, or when a specified quantity of times of training is reached, the training ending condition is met.

In this embodiment, the server trains the multi-modal feature extraction model by using the sample pair including the visual content and the description text for the visual content, so that the trained multi-modal feature extraction model performs feature extraction on inputted multi-modal information and outputs features in corresponding modalities. This can strengthen an association between a textual modality feature and a visual modality feature, and ensure feature extraction accuracy of the multi-modal feature extraction model, to help improve accuracy of determining the video tag.

In an exemplary embodiment, the separately performing feature extraction on the visual content and the description text by using a to-be-trained initial multi-modal feature extraction model to obtain a sample-pair visual feature of the visual content and a sample-pair textual feature of the description text includes: when the visual content included in the sample pair is video content, determining at least one video frame in the video content, extracting a visual feature of the at least one video frame by using the to-be-trained initial multi-modal feature extraction model, and obtaining a sample-pair visual feature of the video content based on the visual feature of the at least one video frame; and determining the description text included in the sample pair, and performing textual feature extraction on the description text included in the sample pair by using the to-be-trained initial multi-modal feature extraction model to obtain the sample-pair textual feature of the description text.

The visual content included in the sample pair may be video content or picture content. To be specific, the sample pair may include an image-text pair and a video-text pair, the image-text pair may include image content and description text for the image content, and the video-text pair may include video content and description text for the video content.

For example, when the visual content included in the sample pair is video content (in other words, when the sample pair is a video-text pair), to ensure consistency between feature dimensions of visual features, the server may perform visual feature extraction on at least one video frame in the video content by using the initial multi-modal feature extraction model, to obtain a visual feature corresponding to the at least one video frame. In a specific application, the server may perform video frame sampling on the video content to obtain the at least one video frame. For each video frame obtained through sampling, the server performs feature extraction by using the initial multi-modal feature extraction model, to obtain a visual feature of each video frame. The server obtains a sample-pair visual feature of the video content based on the visual feature of the at least one video frame. In a specific application, when a quantity of the at least one video frame is 1, the server may directly determine a sample-pair visual feature based on a visual feature of the single video frame. For example, the server may directly use the visual feature of the single video frame as the sample-pair visual feature. When a quantity of the at least one video frame is greater than or equal to 2, the server may fuse visual features of the video frames. For example, the server may perform average pooling and fusion, to obtain a sample-pair visual feature having a feature dimension the same as that of a single image. For the description text in the video-text pair, the server performs textual feature extraction on the description text by using the initial multi-modal feature extraction model, to obtain a sample-pair textual feature of the description text.

In this embodiment, for the sample pair including the video content, the server performs visual feature extraction on the at least one video frame in the video content, and obtains the sample-pair visual feature based on the visual feature of the at least one video frame. Performing textual feature extraction on the description text by using the initial multi-modal feature extraction model can ensure that the sample-pair visual feature of the video content has the same feature dimension as that of a sample-pair visual feature of the image content. In this way, model training based on the video content and model training based on the image content are unified, to ensure that the multi-modal feature extraction model can accurately extract features in various modalities.

In an exemplary embodiment, the at least two modalities include the visual modality and the textual modality. The modality information of the at least two modalities includes the visual modality information and the textual modality information. Performing tag prediction based on the at least one candidate tag and the modality information of the at least two modalities to obtain a video tag for the video includes: concatenating the textual modality information and the at least one candidate tag to obtain concatenated text; and determining a visual feature corresponding to the visual modality information, and performing tag prediction based on the concatenated text and the visual feature corresponding to the visual modality information to obtain the video tag for the video.

The modality information extracted for the video includes the visual modality information corresponding to the visual modality and the textual modality information corresponding to the textual modality. The candidate tag is information in a text form, and the concatenated text is obtained by concatenating the textual modality information and the candidate tag.

Specifically, the server may concatenate the textual modality information and the determined candidate tag to obtain the concatenated text for the video. During specific implementation, the server may sequentially concatenate the textual modality information and the candidate tag according to a preset concatenation sequence to obtain the concatenated text. The server performs tag prediction based on the concatenated text and the visual feature corresponding to the visual modality information to obtain the video tag for the video. The visual feature is obtained by performing feature extraction on the visual modality information. For example, a corresponding visual feature may be extracted for the visual modality information by using a pre-trained multi-modal feature extraction model. In some embodiments, tag prediction may be performed for the concatenated text and the visual feature by using a pre-trained tag prediction model. Specifically, the concatenated text and the visual feature may be inputted to the tag prediction model for tag prediction, and the tag prediction model outputs the video tag for the video.

In this embodiment, after concatenating the textual modality information and the candidate tag, the server may perform tag prediction based on the concatenated text and the visual feature corresponding to the visual modality information, and perform tag prediction based on the candidate tag and the modality information of the at least two modalities. The candidate tag is introduced into the tag prediction, to enhance information targeted by the tag prediction, and improve accuracy of determining the video tag.

In an exemplary embodiment, the performing tag prediction based on the concatenated text and the visual feature corresponding to the visual modality information to obtain the video tag for the video includes: performing, by using a feature alignment model, feature alignment on the visual feature corresponding to the visual modality information to obtain a visual alignment feature; and performing tag prediction by using a tag prediction model based on the concatenated text and the visual alignment feature to obtain the video tag for the video.

The feature alignment model is configured for performing feature alignment on the visual feature corresponding to the visual modality information, to map the visual feature to a feature suitable for processing by the tag prediction model. The feature alignment model may be obtained through pre-training according to an actual requirement. The visual alignment feature is a feature obtained by performing, by using the feature alignment model, feature alignment on the visual feature corresponding to the visual modality information. The visual alignment feature is suitable for being inputted to the tag prediction model for processing. For example, a quantity of feature dimensions of the tag prediction model matches a quantity of input feature dimensions of the tag prediction model. The tag prediction model is configured for performing tag prediction for the inputted concatenated text and visual feature. The tag prediction model may be obtained through pre-training based on various artificial neural network algorithms or a deep learning algorithm according to an actual requirement. For example, the server may obtain the tag prediction model through pre-training based on at least one of the CNN algorithm, the RNN algorithm, the LSTM algorithm, the GAN algorithm, the AE algorithm, a large language model (LLM) algorithm, or the DBN algorithm.

For example, the server may determine the pre-trained feature alignment model, and perform, by using the feature alignment model, feature alignment on the visual feature corresponding to the visual modality information. Specifically, the server may input, to the feature alignment model, the visual feature corresponding to the visual modality information, so that the feature alignment model performs alignment mapping on the visual feature to obtain the visual alignment feature. The server inputs the concatenated text and the visual alignment feature to the pre-trained tag prediction model, so that the tag prediction model performs tag prediction and outputs the video tag for the video.

In this embodiment, after performing feature alignment on the visual feature corresponding to the visual modality information by using the feature alignment model, the server performs tag prediction based on the concatenated text and the visual alignment feature by using the tag prediction model. By performing mapping for the visual feature, normal tag prediction by the tag prediction model is ensured, to ensure accuracy of determining the video tag.

In an exemplary embodiment, an operation of training the feature alignment model and the tag prediction model includes: obtaining a first sample visual feature of a first sample video and sample description information for the first sample video, the first sample visual feature being extracted for visual modality information of the first sample video; performing training based on the first sample visual feature of the first sample video and the sample description information for the first sample video to obtain an intermediate feature alignment model; obtaining a second sample visual feature, sample textual modality information, and a sample tag of a second sample video, the second sample visual feature being extracted for visual modality information of the second sample video; performing feature alignment on the second sample visual feature by using the intermediate feature alignment model to obtain a second sample alignment feature; performing tag prediction by using a to-be-trained initial tag prediction model based on the sample textual modality information and the second sample alignment feature to obtain a predicted tag for the second sample video; and updating the intermediate feature alignment model and the initial tag prediction model based on the predicted tag and the sample tag to obtain a trained feature alignment model and tag prediction model.

The intermediate feature alignment model is a feature alignment model obtained through preliminary training based on the first sample visual feature of the first sample video and the sample description information. The first sample visual feature is obtained by performing visual feature extraction on the visual modality information of the first sample video, and the sample description information for the first sample video is configured for describing video content of the first sample video. The second sample video is configured for jointly training the feature alignment model and the tag prediction model, and the second sample visual feature is extracted based on the visual modality information of the second sample video. The sample textual modality information is modality information extracted for the second sample video based on the textual modality, and may specifically include but is not limited to a title, a subtitle, a speech recognition result, a character recognition result, and the like of the second sample video. The sample tag is a tag pre-added to the second sample video.

In some embodiments, the server may obtain the first sample visual feature of the first sample video and the sample description information for the first sample video, and perform preliminary training based on the first sample visual feature of the first sample video and the sample description information for the first sample video, to obtain the intermediate feature alignment model. The server obtains the second sample visual feature, the sample textual modality information, and the sample tag of the second sample video. The server inputs the second sample visual feature to the intermediate feature alignment model obtained through preliminary training, so that the intermediate feature alignment model correspondingly performs feature alignment and outputs the second sample alignment feature. The server inputs the sample textual modality information and the second sample alignment feature to a to-be-trained initial tag prediction model, so that the initial tag prediction model performs tag prediction and outputs the predicted tag for the second sample video. The server updates the intermediate feature alignment model and the initial tag prediction model based on the predicted tag and the sample tag, continues to perform joint training by using a next second sample video, and ends training when a model training condition is met, to obtain the trained feature alignment model and tag prediction model. In some embodiments, the server may determine a tag difference between the predicted tag and the sample tag, separately update model parameters of the intermediate feature alignment model and the initial tag prediction model based on the tag difference, and continue to perform joint training until the training ends, to obtain the trained feature alignment model and tag prediction model.

In this embodiment, the server preliminarily trains the intermediate feature alignment model and performs joint training on the intermediate feature alignment model and the initial tag prediction model, to ensure model training effect of the feature alignment model and the tag prediction model, and ensure accuracy of determining the video tag based on the feature alignment model and the tag prediction model.

In an exemplary embodiment, the performing training based on the first sample visual feature of the first sample video and the sample description information for the first sample video to obtain an intermediate feature alignment model includes: performing feature alignment on the first sample visual feature by using a to-be-trained initial feature alignment model to obtain a first sample alignment feature; performing video description on the first sample alignment feature by using the to-be-trained initial tag prediction model to obtain model description information for the first sample video; and updating the initial feature alignment model based on the model description information and the sample description information and continuing to perform training until the training ends, to obtain the intermediate feature alignment model.

The first sample video is sample data configured for preliminarily training the feature alignment model. The first sample visual feature is obtained by performing visual feature extraction on the visual modality information of the first sample video, and may be specifically obtained by performing feature extraction on a video frame in the first sample video. The sample description information is configured for describing the first sample video, and may specifically describe the video content of the first sample video. The initial feature alignment model is a to-be-trained raw feature alignment model, and the initial tag prediction model is a to-be-trained raw tag prediction model.

For example, the server may determine the first sample video configured for preliminarily training the feature alignment model, and obtain the first sample visual feature of the first sample video and the sample description information for the first sample video. The server inputs the first sample visual feature to the to-be-trained initial feature alignment model, so that the initial feature alignment model performs feature alignment and outputs the first sample alignment feature. The server inputs the first sample alignment feature to the to-be-trained initial tag prediction model, so that the initial tag prediction model describes the video and outputs the model description information for the first sample video. The server updates the initial feature alignment model based on the model description information and the sample description information, and continues to perform training until the training ends, to obtain the intermediate feature alignment model. In some embodiments, the server may determine a description information difference between the model description information and the sample description information, update a model parameter of the initial feature alignment model based on the description information difference, continue to perform training based on a next first sample video, and end training when a model training condition is met, to obtain the intermediate feature alignment model.

In this embodiment, the feature alignment model is preliminarily trained based on the first sample visual feature of the first sample video and the sample description information, to preferentially ensure that the feature alignment model can accurately perform alignment mapping on an inputted visual feature, to ensure normal tag prediction by the tag prediction model.

In an exemplary embodiment, the determining at least one candidate tag for the video based on the respective multi-modal retrieval tags of the modality information of the at least two modalities includes: collecting statistics on the respective multi-modal retrieval tags of the modality information of the at least two modalities to obtain a tag statistics result; and determining the at least one candidate tag for the video based on the tag statistics result.

The tag statistics result is obtained by collecting statistics on the multi-modal retrieval tag. The tag statistics result may specifically include a frequency statistics result of the multi-modal retrieval tag. To be specific, the tag statistics result records frequency of each tag in the multi-modal retrieval tag.

In some embodiments, the server may collect statistics on respective multi-modal retrieval tags of various types of modality information, and may specifically collect statistics on frequency of the tags, to obtain the tag statistics result. The server may determine, based on the tag statistics result, the at least one candidate tag for the video from the respective multi-modal retrieval tags of various types of modality information. For example, when the tag statistics result includes a frequency count, the server may determine K tags with largest frequency counts as candidate tags for the video. In some embodiments, when statistics are collected on the respective multi-modal retrieval tags of various types of modality information, different statistics weights may be set for different types of modality information according to an actual requirement, so that weighted statistics collection is performed on the respective multi-modal retrieval tags of various types of modality information based on the statistics weights, to obtain the tag statistics result.

In this embodiment, the server collects statistics on the respective multi-modal retrieval tags of various types of modality information, and determines the candidate tag based on the tag statistics result. The candidate tag may be determined based on a multi-modal retrieval tag corresponding to multi-modal information. Accuracy of the candidate tag can be ensured. When the candidate tag is introduced into the tag prediction, accuracy of determining the video tag can be improved.

This application further provides an application scenario, and the foregoing video tag processing method is applied to the application scenario. Specifically, the video tag processing method is applied to the application scenario as follows:

Video tag identification is an important part of a video content feature. Tags are automatically generated for massive user-generated content (UGC) videos through a machine, and video content features at different granularities may be provided for a downstream content delivery link such as a recommendation system and content operation, to improve content delivery efficiency and greatly reduce costs of manual content review. Due to diversity of UGC video content, a quantity of tags in a tag library used in a service scenario may usually reach hundreds of thousands or even millions. Consequently, it is difficult to tag each video with a corresponding content tag.

In the related art, tag identification methods may be roughly classified into the following two types from a perspective of model implementation: (1) Classification-based method: A common method is to mark a batch of videos with content tags corresponding to the videos, construct a training set to train a classification model, and then tag a new video by using the model. The model usually fuses multi-modal features, and a fully connected layer (each neuron corresponds to a specific tag) is connected to a fusion feature to predict whether each tag exists. (2) Retrieval-based method: A video-to-video-to-tag (v2v2t) method is usually for retrieval. A feature of a video is extracted based on a trained encoder, and manually marked data is processed into a form of <video feature, tag list> and written to a retrieval library. For a video that needs to be tagged, a feature is first extracted by using the same encoder, and the retrieval library is searched for videos with similar content. A tag list corresponding to top-K (the first K) similar videos is used as candidate tags, and a final result is obtained through an aggregation module (for example, voting).

Regardless of classification or retrieval, a core algorithm module is multi-modal feature extraction and fusion. In a method for tagging a current video set, a multi-modal content understanding framework in a short-video scenario is basically reused: A plurality of types of modality information included in a raw video medium, such as a video frame sequence, text information (a video title, optical character recognition (OCR) text, and the like), and automatic speech recognition (ASR) extracted from an audio signal, are inputted to a multi-modal model for feature extraction and fusion, and a video content tag is finally predicted. In a structure of the multi-modal model, each modality may separately have an independent encoder, and modality features are separately extracted and then fused; or a token of a video frame processed by a visual feature encoder and a text token may be inputted to a transformer for fusion and prediction; or features in other modalities may be tokenized and then inputted to an LLM together with text, to obtain a prediction result through generation.

The transformer is a network structure model suitable for processing sequence data, and uses a full attention structure to replace a conventional RNN or CNN. A core idea of the transformer is to model a relationship between each element in an input sequence and other elements into an attention weight matrix, and calculate a representation of each element by using a self-attention mechanism. This structure enables the transformer to have a strong capability in capturing a long-distance dependency relationship in a sequence, to achieve good performance in a natural language processing (NLP) task. The transformer model is quite widely applied to the NLP field, including tasks of machine translation, text abstraction, a question-answering system, and the like. The self-attention mechanism is introduced into the model for the first time, and the model has surpassed conventional sequence-to-sequence (Seq2Seq) models such as an LSTM model and a gated recurrent unit (GRU) model in many aspects. Success of the transformer also leads to many variant models based on the self-attention mechanism, such as bidirectional encoder representations from transformers (BERT) and a generative pre-trained transformer (GPT). These models make significant progress in NLP tasks. The token is a word or a sub-word in text, and is a basic unit used by a model to process the text.

The LLM learns statistical rules and semantic information of a language by training a large amount of text data, to predict a next word or sentence. The LLM is widely applied to the NLP field, such as machine translation, speech recognition, and text generation. The LLM may use different training policies and model structures for, for example, pre-training and fine tuning. The pre-training is to perform large-scale training on a model in an unsupervised or self-supervised case, to enable the model to have general understanding and expression capabilities for language data. The fine tuning is to enable, based on a pre-trained model through supervised learning, the model to be optimized for a specific application scenario or task. The LLM achieves significant results in tasks of language understanding, generation, translation, and the like. With continuous expansion of a model size and an increase in training data, performance and an application scope of the LLM are also continuously extended.

As shown in FIG. 8, regardless of a specific structure of the multi-modal model, a process of video tag identification may be abstracted as follows: extracting a plurality of types of modality information for a video, including a video frame, a title, an OCR result, an ASR result, and the like; and performing tag prediction for the multi-modal information of the video by using the multi-modal model, to obtain a tag result. However, a current method of a multi-modal large model mainly implements question-answering of a general visual task or an NLP task. The OCR is a technology for detecting and recognizing text content from an image, and the ASR is a technology for converting human speech into text.

The related art has disadvantages in many aspects: The classification-based method can support only a closed tag set defined during training, and if a tag needs to be added or deleted, an entire model needs to be re-trained, causing time and labor costs in data marking and model training. The retrieval-based method can flexibly support a new tag. This may be specifically implemented by refreshing a retrieval library, without updating a model. However, performance of this method is usually limited by effect of a multi-modal feature. In addition, a tag that does not exist in the retrieval library cannot be covered.

A multi-modal large language model (MLLM) method is usually designed as a general-purpose model to support a plurality of perceptual and cognitive tasks in a question-answering form. Based on the LLM, the MLLM integrates media data in other modalities, such as an image, a video, and audio, so that the model can simultaneously process information of different modalities and better understand and express semantics, to improve effect and accuracy of an application. This method may be directly applied to a tag identification task. However, for a tag generation task, no candidate tag is provided, and effect of directly training the MLLM to generate a tag from zero is significantly poorer than effect of providing some candidate tags for guidance. A similar method is also used in tag generation with GPT (TagGPT). First, a candidate tag library is generated by using a chat generative pre-trained transformer (ChatGPT) and post-processed. A generated result matches the candidate tag library, and generated content is controlled to some extent. However, the TagGPT recognizes all video content by using a method like object detection or OCR and then textualizes all the video content, and a subsequent model performs processing in a pure-text form. This operation theoretically leads to loss of much information.

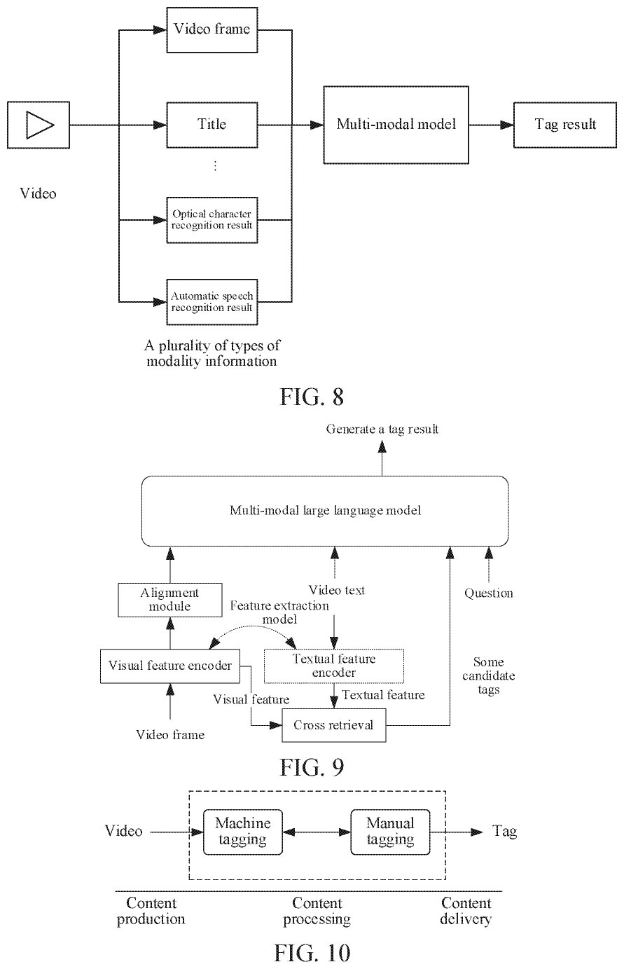

To resolve the foregoing problems, the video tag processing method provided in this embodiment relates to a tag generation method based on a retrieval-enhanced multi-modal large model. The video tag processing method provided in this embodiment is based on an MLLM framework. A simple cross retrieval module is designed to obtain some candidate tags and input the candidate tags to the large model, to enhance an input feature and provide guidance for a generation task, so that effect of generating a tag result can be significantly improved. In addition, two input features are needed for cross retrieval: A visual feature is an input feature from an MLLM alignment module, without additional calculation. A feature encoder needed for textual feature calculation is a by-product of training a visual encoder through CLIP, without separate training, so that overall calculation is lightweight. As shown in FIG. 9, for a video frame of a video, feature encoding is performed by using a visual feature encoder in a feature extraction model to obtain a visual feature, and the visual feature is aligned by using an alignment module and then inputted to an MLLM. For video text of the video, the video text is inputted to the MLLM, and the video text may include a title of the video, an OCR result, an ASR result, and the like. In addition, a textual feature of the video text is obtained by using a textual feature encoder in the feature extraction model, cross retrieval is performed based on the visual feature and the textual feature to obtain some candidate tags, and the candidate tags and a question prompt word are inputted to the MLLM, so that the MLLM generates a tag result for the video based on the visual feature processed by the alignment module, the video text, and the candidate tags.

The video tag processing method provided in this embodiment may be applied to a content delivery scenario. As shown in FIG. 10, a video enters a content processing link from a content production process, and a corresponding content feature is obtained through human-computer collaboration and enters a downstream content delivery process. The video tag processing method provided in this embodiment belongs to a machine tagging process during video content processing. Specifically, during video content processing, the video may be tagged in a collaborative manner of machine tagging and manual tagging. In other words, a corresponding video tag is added to the video.

The video tag processing method provided in this embodiment may relate to a method based on a retrieval-enhanced multi-modal large model, to adapt to tag identification tasks for various videos. In the video tag processing method provided in this embodiment, a tag identification problem is defined as a text generation task, and a tag result is obtained in an end-to-end manner through decoding based on the MLLM. In addition, a lightweight retrieval enhancement module is introduced into the video tag processing method provided in this embodiment, to pre-obtain some candidate tags, to enhance an input feature and provide guidance for a generation task, so that tag generation effect can be significantly improved.

For the visual feature encoder and the textual feature encoder included in the feature extraction model, the visual feature encoder and the textual feature encoder are trained through CLIP in this embodiment. The CLIP algorithm is a multi-modal learning technology intended to train a model to enable the model to understand and process image and text data. The CLIP algorithm achieves this objective by training a text and image model, and improves model performance through contrast learning. In the CLIP algorithm, the text and image model is trained by using a large quantity of images and related descriptions. The model learns to map text and image representations to same semantic space, so that text and an image that have similar meanings have similar representations in the space. For example, the model may associate a representation of a word “dog” with a picture representation of a dog, and the contrast learning plays a key role in the CLIP algorithm. During training, the model needs to distinguish between a positive sample (that is, a correct description matching an image) and a negative sample (that is, a description not matching an image). The model achieves this objective by maximizing a similarity between positive samples and minimizing a similarity between negative samples. This method enables the model to learn a more robust and generalized representation.

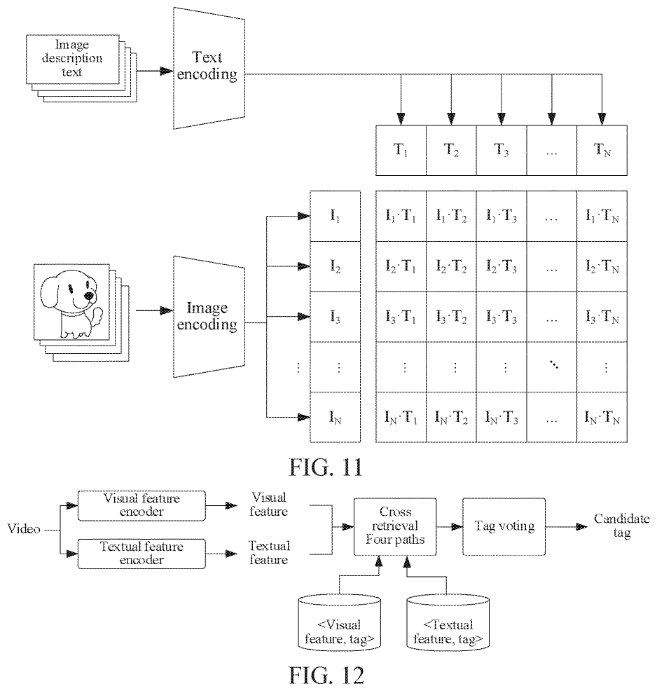

As shown in FIG. 11, for an image and image description text, a visual feature I is extracted for the image by using a visual feature encoder, a textual feature T is extracted for the image description text by using a textual feature encoder, and an image-text feature pair (Iᵢ·Tᵢ) between the visual feature I and the textual feature T is constructed. For each image-text feature pair, an objective of the CLIP model is to maximize a similarity between the image and the text, and minimize a similarity with another irrelevant image-text pair. Specifically, the CLIP algorithm measures a similarity of the image-text feature pair (Iᵢ·Tᵢ) by using an information noise contrastive estimation (InfoNCE) loss function. For a pair of positive sample image xᵢ and textyᵢ, and K negative sample images and text, the InfoNCE loss function is defined as follows:

$${L}_{CLIP} = - log \frac{exp ( {v}_{i}^{T} {t}_{i} / τ )}{exp ( {v}_{i}^{T} {t}_{i} / τ ) + {\sum }_{j = 1}^{K} exp ( {v}_{i}^{T} {t}_{i} / τ )}$$

L_{CLIP} is a model loss, τ is a temperature hyper-parameter for controlling similarity distribution, exp( ) is a power operation with a natural constant as a base, and vᵢ and tᵢ represent a feature vector of the image xᵢ and a feature vector of the text yᵢ respectively.

In this embodiment, two types of data are used for training: an image-text pair and a video-text pair. Data such as picture-description text and video-video title may be naturally obtained from service data, without manual marking. A vision transformer (ViT) is used as a visual encoder, and BERT is used as a text encoder. In addition, an encoder structure may alternatively be replaced with another network structure.

During training, in this embodiment, some modifications are made to a training process of the CLIP, to adapt to media in two different forms: a picture and a video. For picture data, a training process is consistent with that of the CLIP. For video data, a sampling mode of a temporal segment network (TSN) may be used. To be specific, frames are extracted from a video at a rate of 1 frame per second, and then the video is equally divided into N segments. One frame is randomly selected from each segment in a training mode, and one frame in the middle is randomly selected from each segment in a test mode, to obtain a total of N frames. N frames of pictures are encoded by the ViT and then directly undergo average pooling to obtain a feature dimension consistent with that of the pictures for training. In this way, a training manner for the image-text pair and a training manner for the video-text pair are unified. After training is completed, a visual feature encoder (denoted as Ev) may be obtained. The visual feature encoder is configured to extract a visual feature in the MLLM. In addition, a by-product, namely, a textual feature encoder (denoted as Et) is obtained, and is configured to extract a textual feature in the cross retrieval module.

For the cross retrieval module, the retrieval-based method is based on the concept of v2v2t. Therefore, a video embedding (emb) obtained through fusion of multi-modal features is needed for search for a similar video. This embodiment further follows a design idea of minimizing additional calculation modules. No video emb is used for searching for a similar video, but cross searching is performed based on a visual emb and a textual emb of a video. A visual emb and a textual emb obtained through training in the CLIP mode are mapped to same semantic space, so that text and an image that have similar meanings have similar representations in the space. Therefore, if content of a video a is similar to content of a video b, distances between four embs, that is, visual embs and textual embs of the videos a and b, are close. Therefore, a visual emb (or a textual emb) of a video may be configured for searching for a similar visual emb or textual emb to find a similar video, and a tag result corresponding to the similar video is migrated as a candidate.

The cross retrieval may be specifically implemented through the following operations:

Operation 1: In an offline processing stage, <video, manually reviewed tag list> in a training set is processed into <visual feature, manually reviewed tag list> and <textual feature, manually reviewed tag list>, and two retrieval libraries are established, including a visual feature tag retrieval library and a textual feature tag retrieval library. The retrieval libraries may be specifically implemented by using a Facebook AI Similarity Search (FAISS) framework or the like.

Operation 2: In an online processing stage, after a visual feature v and a textual feature t are separately extracted for a to-be-processed video, retrieval is separately performed in the two retrieval libraries to return a tag list corresponding to a video with a similarity>θ, where θ is a hyper-parameter, to obtain four recalled tag results (the visual feature v is configured for searching for a similar visual feature and textual feature, that is, v-to-v (v2v) and v-to-t (v2t); and similarly, the textual feature t is configured for performing t-to-v (t2v) and t-to-t (t2t)).

Operation 3: In an online processing stage, the four recalled tag results are combined, statistics are collected on frequency, and top-K (K is a hyper-parameter) tags are used as a final result. The tag results herein are inputted only as a guiding signal for the MLLM, and a value of K may be properly increased to increase a recall rate, so that the MLLM selects a correct tag from the tag results.

As shown in FIG. 12, a visual feature encoder and a textual feature encoder separately process a video to extract a visual feature v and a textual feature t, and cross retrieval is performed based on the visual feature v and the textual feature t. Specifically, retrieval is separately performed in a visual feature retrieval library and a textual feature retrieval library. To be specific, the visual feature v is configured for searching for a similar visual feature and textual feature, that is, v2v and v2t; and similarly, the textual feature tis configured for performing t2v and t2t. Tag voting is performed on four cross retrieval results that are obtained, and top-K tags may be used as candidate tags. In some embodiments, weights may be further introduced. Specifically, an offline verification set may be determined. A tag may alternatively be obtained through one of the four paths of retrieval: v2v, t2v, t2t, and v2t. Weights are set based on single-path effect on the verification set, and a higher weight is assigned to a path with higher recall accuracy. Otherwise, 1/4 is used for all the four paths. In other words, no weighting is performed.

For the retrieval-enhanced MLLM, the multi-modal model may be trained by using the MLLM. The MLLM model receives two inputs, including a visual feature token and text. The visual feature token is obtained through processing based on a visual feature encoder, and the visual feature encoder is obtained through training in the CLIP mode. To align to an input for the LLM, the visual token is followed by an alignment module P. The alignment module P includes a learnable parameter matrix, and is mainly configured to map a visual feature to an input dimension of the LLM, and convert the visual feature into a token matching the LLM, where the token is denoted as [video_emb]. The text includes a title of a video, description text, ASR, and the like. In addition, some candidate tags recalled by the cross retrieval module are inputted as a guiding signal. The candidate tags are also in a pure-text form, are expressed as “Some candidate tags of the video are xxx, xxx, xxx, . . . ”, are concatenated with the video text, and are denoted as [video_txt].

The LLM may be an open-source Chinese LLM such as Chinese-LLaMA or BLOOM. An input prompt word template is as follows:
“###Human: [video_emb][video_txt][instruct] ###Assistant:”

The LLM generates, based on the input, a tag result obtained through inference.

“###Human:” and “###Assistant:” are two common training templates, and are used for a machine to understand that Human is followed by an instruction and Assistant indicates to start to answer a question. [video_emb], [video_txt], and [instruct] are a video visual token, a video text token, and an instruction text token respectively.

Further, training of the MLLM includes two phases, including pre-training for the feature alignment module in a phase 1 and instruction fine-tuning training for the feature alignment module and the MLLM in a phase 2.

Regarding the pre-training for the feature alignment module in the phase 1, in this phase, all parameters of the visual feature encoder and the LLM are fixed, and only the alignment module P is trained, to mainly align the visual token to the LLM. Training data in this phase is a<video, video description text> pair. A<short video, video title> pair in a service scenario is still used herein, to train the model to generate a brief description of video content. The following prompt words are used:
“###Human: [video_emb][alignment instruction] ###Assistant:”

The alignment instruction may be diversified. For example, at least one of the following statements is used: “Briefly describe the following video”, “Provide a brief description of the given video clip”, “Briefly describe the provided video clip”, “Summarize visual content of the following video”, “Briefly and clearly describe the following video clip”, “Briefly describe the meaning of the provided video”, “Briefly describe key characteristics of the clip”, “Briefly describe content of the presented video”, “Provide a brief and clear summary for the following video”, “Write an informative summary for the following video clip”, and “Present the provided video in a brief narrative manner”.

Regarding instruction fine-tuning training for the feature alignment module and the MLLM in the phase 2, a parameter of the visual feature encoder is fixed, and parameters of the alignment module and the LLM are open for training. A training objective of this phase is to construct a corresponding instruction based on<video, tag> data in an actual service scenario, to perform instruction fine-tuning to generate tag list text:
“###Human: [video_emb][video_txt][instruct] ###Assistant:”

Similar to the alignment instruction in the phase 1, instruct may also be configured for designing a synonymous instruction, to improve training effect, such as: “What tag may be used to summarize the foregoing video?”, “Output some key content tags based on content of the foregoing video”, or “Generate a main content tag based on the foregoing video content”

In this embodiment, the by-product, namely, the textual feature encoder, generated through CLIP is only for use by the cross retrieval module, and a parameter of the textual feature encoder and a parameter the visual feature encoder remain unchanged and do not participate in training. In addition, based on a service scenario, most background audio in short videos is uniform background music (bgm) and is not well discriminable, and important oral information has been extracted through ASR and combined with video text information. Therefore, the model designed in this embodiment does not use a raw audio signal as an input.

Further, model-based inference is performed. After model training is completed, a tag may be predicted for a new video. Frame extraction is performed on the video to obtain N frames of images of the video, N features are obtained by using the visual feature encoder, and an input visual token is obtained through conversion by the alignment module. After average pooling is performed on the N features, cross retrieval is performed on the N features and features obtained by performing textual feature encoding on text information (including a title, ASR text, and the like) of the video, to obtain some candidate tags. The candidate tags are concatenated with text information and a question instruction to obtain a text token. The visual and text tokens are inputted to the LLM for decoding to generate a tag result.

In another embodiment, both the visual feature encoder and the textual feature encoder may be replaced with networks of other structures, and the alignment module for aligning the visual feature to the input for the LLM may alternatively be replaced with another structure, such as a querying former (Q-Former). The LLM framework in the main process of this embodiment may alternatively be replaced with another generative model, and the retrieval module may alternatively be modified into another similar implementation.

The video tag processing method provided in this embodiment provides the retrieval-enhanced MLLM based on a general-purpose MLLM framework. An implementation method is simple. The cross retrieval module is skillfully designed by using intermediate results of the MLLM, and some candidate tags are recalled and inputted to the large model as a guiding signal, to enhance an input feature, and guide the model to generate a tag result with better effect.

Although the operations are shown sequentially according to the instructions of the arrows in the flowcharts of the foregoing embodiments, the operations are not necessarily performed sequentially according to the sequence instructed by the arrows. Unless otherwise explicitly specified in this application, an execution sequence of the operations is not strictly limited, and the operations may be performed in other sequences. Moreover, at least some of the operations in the flowcharts in the foregoing embodiments may include a plurality of operations or a plurality of stages. The operations or stages are not necessarily performed at the same moment but may be performed at different moments. The operations or stages are not necessarily performed sequentially, but may be performed alternately with other operations or at least some of operations or stages of other operations.

Based on a same inventive concept, embodiments of this application further provide a video tag processing apparatus for implementing the foregoing video tag processing method. Implementation solutions provided by the apparatus for resolving problems are similar to the implementation solutions described in the foregoing method. Therefore, specific limitations in one or more video tag processing apparatus embodiments provided below may incorporate the video tag processing method in the foregoing descriptions. Details are not described herein again.

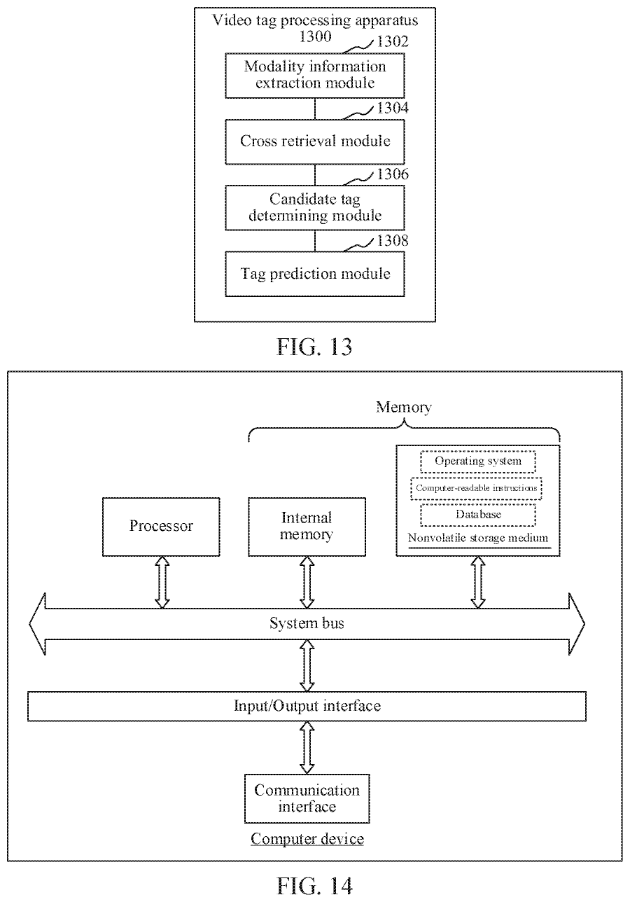

In an exemplary embodiment, as shown in FIG. 13, a video tag processing apparatus 1300 is provided, including a modality information extraction module 1302, a cross retrieval module 1304, a candidate tag determining module 1306, and a tag prediction module 1308.

The modality information extraction module 1302 is configured to determine a to-be-processed video, and extracting modality information of at least two modalities for the video.

The cross retrieval module 1304 is configured to separately perform cross retrieval based on the modality information of the at least two modalities and feature dimensions of the at least two modalities to obtain respective multi-modal retrieval tags of the modality information of the at least two modalities.

The candidate tag determining module 1306 is configured to determine at least one candidate tag for the video based on the respective multi-modal retrieval tags of the modality information of the at least two modalities.

The tag prediction module 1308 is configured to perform tag prediction based on the at least one candidate tag and the modality information of the at least two modalities to obtain a video tag for the video.

In an embodiment, the cross retrieval module 1304 is further configured to: determine a multi-modal feature tag library, the multi-modal feature tag library including reference modality features of a reference video in the at least two modalities and reference tags that are respectively pre-determined based on the reference modality features; and respectively perform feature matching between the modality information of the at least two modalities and the reference modality features of the reference video in the at least two modalities to obtain a feature matching result, and retrieve the respective multi-modal retrieval tags of the modality information of the at least two modalities from the multi-modal feature tag library based on the feature matching result.

In an embodiment, the cross retrieval module 1304 is further configured to: separately perform feature matching between each type of modality information in the modality information of the at least two modalities and the reference modality features of the reference video in the at least two modalities to obtain a feature matching result of each type of modality information; determine a target matching result of each type of modality information from the feature matching result of each type of modality information, the target matching result being a feature matching result indicating matching; and determine a reference modality feature corresponding to the target matching result of each type of modality information, and retrieve a multi-modal retrieval tag of each type of modality information from the multi-modal feature tag library based on the reference modality feature corresponding to the target matching result.

In an embodiment, the at least two modalities include the visual modality and the textual modality; the modality information of the at least two modalities includes the visual modality information of the video and the textual modality information of the video; the multi-modal feature tag library includes the visual reference modality feature of the reference video in the visual modality, a visual reference tag corresponding to the visual reference modality feature, the textual reference modality feature of the reference video in the textual modality, and a textual reference tag corresponding to the textual reference modality feature. The cross retrieval module 1304 is further configured to: perform feature extraction based on the visual modality information to obtain a visual feature, and perform feature extraction based on the textual modality information to obtain a textual feature; perform visual feature matching between the visual feature and each of the visual reference modality feature and the textual reference modality feature to obtain a visual feature matching result, and obtain a multi-modal retrieval tag of the visual modality information from the visual reference tag and the textual reference tag based on the visual feature matching result; and perform textual feature matching between the textual feature and each of the visual reference modality feature and the textual reference modality feature to obtain a textual feature matching result, and obtain a multi-modal retrieval tag of the textual modality information from the visual reference tag and the textual reference tag based on the textual feature matching result.

In an embodiment, the cross retrieval module 1304 is further configured to: perform visual feature matching between the visual feature and the visual reference modality feature to obtain a first visual feature matching result; determine a first visual feature matching result indicating matching, determine a visual reference modality feature corresponding to the first visual feature matching result indicating matching, and determine a first visual modality retrieval tag from the visual reference tag based on the visual reference modality feature corresponding to the first visual feature matching result indicating matching; perform visual feature matching between the visual feature and the textual reference modality feature to obtain a second visual feature matching result; determine a second visual feature matching result indicating matching, determine a textual reference modality feature corresponding to the second visual feature matching result indicating matching, and determine a first textual modality retrieval tag from the textual reference tag based on the textual reference modality feature corresponding to the second visual feature matching result indicating matching; and obtain the multi-modal retrieval tag of the visual modality information based on the first visual modality retrieval tag and the first textual modality retrieval tag.

In an embodiment, the cross retrieval module 1304 is further configured to: perform textual feature matching between the textual feature and the visual reference modality feature to obtain a first textual feature matching result; determine a first textual feature matching result indicating matching, determine a visual reference modality feature corresponding to the first textual feature matching result indicating matching, and determine a second visual modality retrieval tag from the visual reference tag based on the visual reference modality feature corresponding to the first textual feature matching result indicating matching; perform textual feature matching between the textual feature and the textual reference modality feature to obtain a second textual feature matching result; determine a second textual feature matching result indicating matching, determine a textual reference modality feature corresponding to the second textual feature matching result indicating matching, and determine a second textual modality retrieval tag from the textual reference tag based on the textual reference modality feature corresponding to the second textual feature matching result indicating matching; and obtain the multi-modal retrieval tag of the textual modality information based on the second visual modality retrieval tag and the second textual modality retrieval tag.

In an embodiment, the operation of performing feature extraction based on the visual modality information to obtain a visual feature, and performing feature extraction based on the textual modality information to obtain a textual feature is implemented by a multi-modal feature extraction model, and a feature extraction model training module is further included, and is configured to: obtain a sample pair, the sample pair including visual content and description text for the visual content; separately perform feature extraction on the visual content and the description text by using a to-be-trained initial multi-modal feature extraction model to obtain a sample-pair visual feature of the visual content and a sample-pair textual feature of the description text; and update the initial multi-modal feature extraction model based on the sample-pair visual feature and the sample-pair textual feature to obtain the multi-modal feature extraction model.

In an embodiment, the feature extraction model training module is further configured to: when the visual content included in the sample pair is video content, determine at least one video frame in the video content, extract a visual feature of the at least one video frame by using the to-be-trained initial multi-modal feature extraction model, and obtain a sample-pair visual feature of the video content based on the visual feature of the at least one video frame; and determine the description text included in the sample pair, and perform textual feature extraction on the description text included in the sample pair by using the to-be-trained initial multi-modal feature extraction model to obtain the sample-pair textual feature of the description text.

In an embodiment, the at least two modalities include the visual modality and the textual modality; the modality information of the at least two modalities includes the visual modality information and the textual modality information; and the tag prediction module 1308 is further configured to: concatenate the textual modality information and the at least one candidate tag to obtain concatenated text; and determine a visual feature corresponding to the visual modality information, and perform tag prediction based on the concatenated text and the visual feature corresponding to the visual modality information to obtain the video tag for the video.

In an embodiment, the tag prediction module 1308 is further configured to: perform, by using a feature alignment model, feature alignment on the visual feature corresponding to the visual modality information to obtain a visual alignment feature; and perform tag prediction by using a tag prediction model based on the concatenated text and the visual alignment feature to obtain the video tag for the video.

In an embodiment, a joint training module is further included, and is configured to: obtain a first sample visual feature of a first sample video and sample description information for the first sample video, the first sample visual feature being extracted for visual modality information of the first sample video; perform training based on the first sample visual feature of the first sample video and the sample description information for the first sample video to obtain an intermediate feature alignment model; obtain a second sample visual feature, sample textual modality information, and a sample tag of a second sample video, the second sample visual feature being extracted for visual modality information of the second sample video; perform feature alignment on the second sample visual feature by using the intermediate feature alignment model to obtain a second sample alignment feature; perform tag prediction by using a to-be-trained initial tag prediction model based on the sample textual modality information and the second sample alignment feature to obtain a predicted tag for the second sample video; and update the intermediate feature alignment model and the initial tag prediction model based on the predicted tag and the sample tag to obtain a trained feature alignment model and tag prediction model.

In an embodiment, the joint training module is further configured to: perform feature alignment on the first sample visual feature by using a to-be-trained initial feature alignment model to obtain a first sample alignment feature; perform video description on the first sample alignment feature by using the to-be-trained initial tag prediction model to obtain model description information for the first sample video; and update the initial feature alignment model based on the model description information and the sample description information and continue to perform training until the training ends, to obtain the intermediate feature alignment model.

In an embodiment, the candidate tag determining module 1306 is further configured to: collect statistics on the respective multi-modal retrieval tags of the modality information of the at least two modalities to obtain a tag statistics result; and determine the at least one candidate tag for the video based on the tag statistics result.

All or some of the modules in the video tag processing apparatus may be implemented by software, hardware, and a combination thereof. The foregoing modules may be embedded in or independent of a processor of a computer device in a form of hardware, or may be stored in a memory of a computer device in a form of software, so that the processor can invoke the modules to perform operations corresponding to the modules.

In an exemplary embodiment, a computer device is provided. The computer device may be a server or a terminal. A diagram of an internal structure of the computer device may be shown in FIG. 14. The computer device includes a processor, a memory, an input/output (I/O) interface, and a communication interface. The processor, the memory, and the I/O interface are connected through a system bus, and the communication interface is connected to the system bus through the I/O interface. The processor of the computer device is configured to provide computation and control ability. The memory of the computer device includes a nonvolatile storage medium and an internal memory. The nonvolatile storage medium has an operating system, computer-readable instructions, and a database stored therein. The internal memory provides an operating environment for the operating system and the computer-readable instructions in the nonvolatile storage medium. The database of the computer device is configured to store video tag processing data. The I/O interface of the computer device is configured for information exchange between the processor and an external device. The communication interface of the computer device is configured to communicate with an external terminal through a network. The computer-readable instructions are executed by the processor to implement a video tag processing method.

A person skilled in the art can understand that the structure shown in FIG. 14 is merely a block diagram of a partial structure related to a solution in this application, and does not constitute a limitation to the computer device to which the solution in this application is applied. Specifically, the computer device may include more or fewer components than those shown in the figure, or some components may be combined, or a different component layout may be used.

In an embodiment, a computer device is further provided, including a memory and a processor. The memory has computer-readable instructions stored therein. The processor, when executing the computer-readable instructions, implements the operations in the foregoing method embodiments.

In an embodiment, a computer-readable storage medium is provided, having computer-readable instructions stored therein. When the computer-readable instructions are executed by a processor, the operations in the foregoing method embodiments are implemented.

In an embodiment, a computer program product is provided, including computer-readable instructions. When the computer-readable instructions are executed by a processor, the operations in the foregoing method embodiments are implemented.

User information (including but not limited to user equipment information, user personal information, and the like) and data (including but not limited to data for analysis, stored data, displayed data, and the like) involved in this application are authorized by users or fully authorized by all parties, and collection, use, and processing of related data need to comply with related regulations.

A person of ordinary skill in the art can understand that all or some of the processes of the methods in the foregoing embodiments may be implemented by computer-readable instructions instructing relevant hardware. The computer-readable instructions may be stored in a non-volatile computer-readable storage medium. When the computer-readable instructions are executed, the processes in the foregoing method embodiments may be implemented. Any reference to a memory, a database, or other media used in the embodiments provided in this application may include at least one of a nonvolatile memory and a volatile memory. The nonvolatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may include a random access memory (RAM), an external cache memory, or the like. For illustration rather than limitation, the RAM may have a plurality of forms, for example, a static random access memory (SRAM) or a dynamic random access memory (DRAM). The database in the embodiments provided in this application may include at least one of a relational database and a non-relational database. The non-relational database may include but is not limited to a blockchain-based distributed database and the like. The processor in the embodiments provided in this application may be but is not limited to a general-purpose processor, a central processing unit, a graphics processing unit, a digital signal processor, a programmable logic device, a data processing logic device based on quantum computing, and the like.

Technical features in the foregoing embodiments may be combined in different manners. To make description concise, not all possible combinations of the technical features in the foregoing embodiments are described. However, all combinations of these technical features shall be considered as falling within the scope recorded in this specification provided that no conflict exists.

The foregoing embodiments merely describe several implementations of this application more specifically and in more detail, but cannot be understood as a limitation to the patent scope of this application. A person of ordinary skill in the art may also make several variations and improvements without departing from the concept of this application. All these variations and improvements fall within the protection scope of this application. Therefore, the protection scope of this application shall be subject to the appended claims.

What is claimed is:

1. A video tag processing method, performed by a computer device, the method comprising:
determining a video to be processed, and extracting modality information of at least two modalities for the video;
separately performing cross retrieval based on the modality information of the at least two modalities and feature dimensions of the at least two modalities to obtain respective multi-modal retrieval tags of the modality information of the at least two modalities;
determining at least one candidate tag for the video based on the respective multi-modal retrieval tags of the modality information of the at least two modalities; and
performing tag prediction based on the at least one candidate tag and the modality information of the at least two modalities to obtain a video tag for the video.

2. The method according to claim 1, wherein the separately performing cross retrieval based on the modality information of the at least two modalities and feature dimensions of the at least two modalities to obtain respective multi-modal retrieval tags of the modality information of the at least two modalities comprises:
determining a multi-modal feature tag library, the multi-modal feature tag library comprising reference modality features of a reference video in the at least two modalities and reference tags that are respectively pre-determined based on the reference modality features; and
respectively performing feature matching between the modality information of the at least two modalities and the reference modality features of the reference video in the at least two modalities to obtain a feature matching result, and retrieving the respective multi-modal retrieval tags of the modality information of the at least two modalities from the multi-modal feature tag library based on the feature matching result.

3. The method according to claim 2, wherein the respectively performing feature matching between the modality information of the at least two modalities and the reference modality features of the reference video in the at least two modalities to obtain the feature matching result, and retrieving the respective multi-modal retrieval tags of the modality information of the at least two modalities from the multi-modal feature tag library based on the feature matching result comprises:
separately performing feature matching between each type of modality information in the modality information of the at least two modalities and the reference modality features of the reference video in the at least two modalities to obtain a feature matching result of each type of modality information;
determining a target matching result of each type of modality information from the feature matching result of each type of modality information, the target matching result being a feature matching result indicating matching; and
determining a reference modality feature corresponding to the target matching result of each type of modality information, and retrieving a multi-modal retrieval tag of each type of modality information from the multi-modal feature tag library based on the reference modality feature corresponding to the target matching result.

4. The method according to claim 2, wherein the at least two modalities comprise a visual modality and a textual modality, the modality information of the at least two modalities comprises visual modality information of the video and textual modality information of the video, and the multi-modal feature tag library comprises a visual reference modality feature of the reference video in the visual modality, a visual reference tag corresponding to the visual reference modality feature, a textual reference modality feature of the reference video in the textual modality, and a textual reference tag corresponding to the textual reference modality feature; and
the respectively performing feature matching between the modality information of the at least two modalities and the reference modality features of the reference video in the at least two modalities to obtain the feature matching result, and retrieving the respective multi-modal retrieval tags of the modality information of the at least two modalities from the multi-modal feature tag library based on the feature matching result comprises:
performing feature extraction based on the visual modality information to obtain a visual feature, and performing feature extraction based on the textual modality information to obtain a textual feature;
performing visual feature matching between the visual feature and each of the visual reference modality feature and the textual reference modality feature to obtain a visual feature matching result, and obtaining a multi-modal retrieval tag of the visual modality information from the visual reference tag and the textual reference tag based on the visual feature matching result; and
performing textual feature matching between the textual feature and each of the visual reference modality feature and the textual reference modality feature to obtain a textual feature matching result, and obtaining a multi-modal retrieval tag of the textual modality information from the visual reference tag and the textual reference tag based on the textual feature matching result.

5. The method according to claim 4, wherein the performing visual feature matching between the visual feature and each of the visual reference modality feature and the textual reference modality feature to obtain the visual feature matching result, and obtaining the multi-modal retrieval tag of the visual modality information from the visual reference tag and the textual reference tag based on the visual feature matching result comprises:
performing visual feature matching between the visual feature and the visual reference modality feature to obtain a first visual feature matching result;
determining a first visual feature matching result indicating matching, determining a visual reference modality feature corresponding to the first visual feature matching result indicating matching, and determining a first visual modality retrieval tag from the visual reference tag based on the visual reference modality feature corresponding to the first visual feature matching result indicating matching;
performing visual feature matching between the visual feature and the textual reference modality feature to obtain a second visual feature matching result;
determining a second visual feature matching result indicating matching, determining a textual reference modality feature corresponding to the second visual feature matching result indicating matching, and determining a first textual modality retrieval tag from the textual reference tag based on the textual reference modality feature corresponding to the second visual feature matching result indicating matching; and
obtaining the multi-modal retrieval tag of the visual modality information based on the first visual modality retrieval tag and the first textual modality retrieval tag.

6. The method according to claim 4, wherein the performing textual feature matching between the textual feature and each of the visual reference modality feature and the textual reference modality feature to obtain the textual feature matching result, and obtaining the multi-modal retrieval tag of the textual modality information from the visual reference tag and the textual reference tag based on the textual feature matching result comprises:
performing textual feature matching between the textual feature and the visual reference modality feature to obtain a first textual feature matching result;
determining a first textual feature matching result indicating matching, determining a visual reference modality feature corresponding to the first textual feature matching result indicating matching, and determining a second visual modality retrieval tag from the visual reference tag based on the visual reference modality feature corresponding to the first textual feature matching result indicating matching;
performing textual feature matching between the textual feature and the textual reference modality feature to obtain a second textual feature matching result;
determining a second textual feature matching result indicating matching, determining a textual reference modality feature corresponding to the second textual feature matching result indicating matching, and determining a second textual modality retrieval tag from the textual reference tag based on the textual reference modality feature corresponding to the second textual feature matching result indicating matching; and
obtaining the multi-modal retrieval tag of the textual modality information based on the second visual modality retrieval tag and the second textual modality retrieval tag.

7. The method according to claim 4, wherein the performing feature extraction based on the visual modality information to obtain the visual feature and the performing feature extraction based on the textual modality information to obtain the textual feature is implemented by a multi-modal feature extraction model, and wherein the training the multi-modal feature extraction model comprises:
obtaining a sample pair, the sample pair comprising visual content and description text for the visual content;
separately performing feature extraction on the visual content and the description text by using a to-be-trained initial multi-modal feature extraction model to obtain a sample-pair visual feature of the visual content and a sample-pair textual feature of the description text; and
updating the initial multi-modal feature extraction model based on the sample-pair visual feature and the sample-pair textual feature to obtain the multi-modal feature extraction model.

8. The method according to claim 7, wherein the separately performing feature extraction on the visual content and the description text by using the to-be-trained initial multi-modal feature extraction model to obtain the sample-pair visual feature of the visual content and the sample-pair textual feature of the description text comprises:
when the visual content comprised in the sample pair is video content, determining at least one video frame in the video content, extracting a visual feature of the at least one video frame by using the to-be-trained initial multi-modal feature extraction model, and obtaining a sample-pair visual feature of the video content based on the visual feature of the at least one video frame; and
determining the description text comprised in the sample pair, and performing textual feature extraction on the description text comprised in the sample pair by using the to-be-trained initial multi-modal feature extraction model to obtain the sample-pair textual feature of the description text.

9. The method according to claim 1, wherein the at least two modalities comprise a visual modality and a textual modality, and the modality information of the at least two modalities comprises visual modality information and textual modality information; and
the performing tag prediction based on the at least one candidate tag and the modality information of the at least two modalities to obtain the video tag for the video comprises:
concatenating the textual modality information and the at least one candidate tag to obtain concatenated text; and
determining a visual feature corresponding to the visual modality information, and performing tag prediction based on the concatenated text and the visual feature corresponding to the visual modality information to obtain the video tag for the video.

10. The method according to claim 9, wherein the performing tag prediction based on the concatenated text and the visual feature corresponding to the visual modality information to obtain the video tag for the video comprises:
performing, by using a feature alignment model, feature alignment on the visual feature corresponding to the visual modality information to obtain a visual alignment feature; and
performing tag prediction by using a tag prediction model based on the concatenated text and the visual alignment feature to obtain the video tag for the video.

11. The method according to claim 10, further comprising: training the feature alignment model and the tag prediction model by:
obtaining a first sample visual feature of a first sample video and sample description information for the first sample video, the first sample visual feature being extracted for visual modality information of the first sample video;
performing training based on the first sample visual feature of the first sample video and the sample description information for the first sample video to obtain an intermediate feature alignment model;
obtaining a second sample visual feature, sample textual modality information, and a sample tag of a second sample video, the second sample visual feature being extracted for visual modality information of the second sample video;
performing feature alignment on the second sample visual feature by using the intermediate feature alignment model to obtain a second sample alignment feature;
performing tag prediction by using a to-be-trained initial tag prediction model based on the sample textual modality information and the second sample alignment feature to obtain a predicted tag for the second sample video; and
updating the intermediate feature alignment model and the initial tag prediction model based on the predicted tag and the sample tag to obtain a trained feature alignment model and tag prediction model.

12. The method according to claim 11, wherein the performing training based on the first sample visual feature of the first sample video and the sample description information for the first sample video to obtain the intermediate feature alignment model comprises:
performing feature alignment on the first sample visual feature by using a to-be-trained initial feature alignment model to obtain a first sample alignment feature;
performing video description on the first sample alignment feature by using the to-be-trained initial tag prediction model to obtain model description information for the first sample video; and
updating the initial feature alignment model based on the model description information and the sample description information and continuing to perform training until the training ends, to obtain the intermediate feature alignment model.

13. The method according to claim 1, wherein the determining the at least one candidate tag for the video based on the respective multi-modal retrieval tags of the modality information of the at least two modalities comprises:
collecting statistics on the respective multi-modal retrieval tags of the modality information of the at least two modalities to obtain a tag statistics result; and
determining the at least one candidate tag for the video based on the tag statistics result.

14. A computer device comprising:
a memory storing a plurality of instructions; and
a processor configured to execute the plurality of instructions, wherein upon execution of the plurality of instructions, the processor is configured to:
determine a video to be processed, and extracting modality information of at least two modalities for the video;
separately perform cross retrieval based on the modality information of the at least two modalities and feature dimensions of the at least two modalities to obtain respective multi-modal retrieval tags of the modality information of the at least two modalities;
determine at least one candidate tag for the video based on the respective multi-modal retrieval tags of the modality information of the at least two modalities; and
perform tag prediction based on the at least one candidate tag and the modality information of the at least two modalities to obtain a video tag for the video.

15. The computer device according to claim 14, wherein to separately perform cross retrieval based on the modality information of the at least two modalities and feature dimensions of the at least two modalities to obtain respective multi-modal retrieval tags of the modality information of the at least two modalities, the processor, upon execution of the plurality of instructions, is configured to:
determine a multi-modal feature tag library, the multi-modal feature tag library comprising reference modality features of a reference video in the at least two modalities and reference tags that are respectively pre-determined based on the reference modality features; and
respectively perform feature matching between the modality information of the at least two modalities and the reference modality features of the reference video in the at least two modalities to obtain a feature matching result, and retrieve the respective multi-modal retrieval tags of the modality information of the at least two modalities from the multi-modal feature tag library based on the feature matching result.

16. The computer device according to claim 15, wherein to respectively perform feature matching between the modality information of the at least two modalities and the reference modality features of the reference video in the at least two modalities to obtain the feature matching result, and retrieve the respective multi-modal retrieval tags of the modality information of the at least two modalities from the multi-modal feature tag library based on the feature matching result, the processor, upon execution of the plurality of instructions, is configured to:
separately perform feature matching between each type of modality information in the modality information of the at least two modalities and the reference modality features of the reference video in the at least two modalities to obtain a feature matching result of each type of modality information;
determine a target matching result of each type of modality information from the feature matching result of each type of modality information, the target matching result being a feature matching result indicating matching; and
determine a reference modality feature corresponding to the target matching result of each type of modality information, and retrieve a multi-modal retrieval tag of each type of modality information from the multi-modal feature tag library based on the reference modality feature corresponding to the target matching result.

17. The computer device according to claim 15, wherein the at least two modalities comprise a visual modality and a textual modality, the modality information of the at least two modalities comprises visual modality information of the video and textual modality information of the video, and the multi-modal feature tag library comprises a visual reference modality feature of the reference video in the visual modality, a visual reference tag corresponding to the visual reference modality feature, a textual reference modality feature of the reference video in the textual modality, and a textual reference tag corresponding to the textual reference modality feature; and
to respectively perform feature matching between the modality information of the at least two modalities and the reference modality features of the reference video in the at least two modalities to obtain the feature matching result, and retrieve the respective multi-modal retrieval tags of the modality information of the at least two modalities from the multi-modal feature tag library based on the feature matching result, the processor, upon execution of the plurality of instructions, is configured to:
perform feature extraction based on the visual modality information to obtain a visual feature, and perform feature extraction based on the textual modality information to obtain a textual feature;
perform visual feature matching between the visual feature and each of the visual reference modality feature and the textual reference modality feature to obtain a visual feature matching result, and obtain a multi-modal retrieval tag of the visual modality information from the visual reference tag and the textual reference tag based on the visual feature matching result; and
perform textual feature matching between the textual feature and each of the visual reference modality feature and the textual reference modality feature to obtain a textual feature matching result, and obtain a multi-modal retrieval tag of the textual modality information from the visual reference tag and the textual reference tag based on the textual feature matching result.

18. The computer device according to claim 14, wherein the at least two modalities comprise a visual modality and a textual modality, and the modality information of the at least two modalities comprises visual modality information and textual modality information; and
wherein to perform tag prediction based on the at least one candidate tag and the modality information of the at least two modalities to obtain the video tag for the video, the processor, upon execution of the plurality of instructions, is configured to:
concatenate the textual modality information and the at least one candidate tag to obtain concatenated text; and
determine a visual feature corresponding to the visual modality information, and perform tag prediction based on the concatenated text and the visual feature corresponding to the visual modality information to obtain the video tag for the video.

19. The computer device according to claim 14, wherein to determine the at least one candidate tag for the video based on the respective multi-modal retrieval tags of the modality information of the at least two modalities, the processor, upon execution of the plurality of instructions, is configured to:
collect statistics on the respective multi-modal retrieval tags of the modality information of the at least two modalities to obtain a tag statistics result; and
determine the at least one candidate tag for the video based on the tag statistics result.

20. A non-transitory computer-readable storage medium storing a plurality of instructions executable by a processor, wherein when executed by the processor, the plurality of instructions is configured to cause the processor to:
determine a video to be processed, and extracting modality information of at least two modalities for the video;
separately perform cross retrieval based on the modality information of the at least two modalities and feature dimensions of the at least two modalities to obtain respective multi-modal retrieval tags of the modality information of the at least two modalities;
determine at least one candidate tag for the video based on the respective multi-modal retrieval tags of the modality information of the at least two modalities; and
perform tag prediction based on the at least one candidate tag and the modality information of the at least two modalities to obtain a video tag for the video.
